(19) United States
(12) Patent Application Publication
(10) Pub. No.: US 2026/0275968 A1
(43) Pub. Date: Sep. 17, 2026

(54) ACTUATOR ASSEMBLY

(71) Applicant: CAMBRIDGE MECHATRONICS LIMITED, Cambridge (GB)

(72) Inventors: Stephen Matthew Bunting, Cambridge (GB); ROBIN EDDINGTON, Cambridge (GB)

(73) Assignee: CAMBRIDGE MECHATRONICS LIMITED, Cambridge (GB)

(21) Appl. No.: 19/675,641

(22) Filed: May 13, 2026

Related U.S. Application Data
(63) Continuation of application No. PCT/GB2024/053014, filed on Dec. 2, 2024.

(30) Foreign Application Priority Data
Dec. 1, 2023 (GB) 2318448.4

(51) Int. Cl. F03G 7/06; G03B 9/06

(52) U.S. Cl. CPC F03G 7/06143; G03B 9/06; G03B 2205/0076

(57) ABSTRACT

An actuator assembly comprising: a base; a rotatable part that is rotatable relative to the base about a primary axis; and one or more actuating units each configured to apply an actuating force capable of rotating the rotatable part relative to the base about the primary axis, each actuating unit comprising: a body portion; a shape memory alloy, SMA, element connected between the body portion and one of the base and the rotatable part and configured, on actuation of the actuating unit, to apply an input force to the body portion; a force-modifying element coupling the body portion and the one of the base and the rotatable part and configured such that the input force is modified to give rise to the actuating force; and a coupling element coupling the body portion to the other of the base and the rotatable part and capable of transmitting the actuating force to the other of the base and the rotatable part.

### FIELD

The present application relates to an actuator assembly. According to certain embodiments, the actuator assembly comprises a rotary actuator assembly, for instance a variable aperture assembly.

### BACKGROUND

There are a variety of apparatuses in which it is desired to provide control of a movable element. SMA elements, for instance SMA wires, may be advantageous as actuators in such apparatuses, for example due to their high energy density which means that the SMA actuator required to apply a given force to the movable element can be relatively small.

One type of apparatus in which SMA wire is known for use as an actuator is in miniature cameras, for example those used in smartphones or other portable electronic devices. WO2011/104518 discloses examples of SMA actuation apparatuses which are suitable for use in miniature cameras.

Variable aperture assemblies within a camera may use SMA elements (for instance, SMA wires) to move the blades so as to adjust the size of the variable aperture. An example of such a variable aperture assembly is disclosed in WO2024/057042: the variable aperture assembly comprises a base, a rotatable part, and an actuator assembly configured to drive rotation of the rotatable part relative to the base about a primary axis to any rotational position within a range of movement. The actuator assembly includes at least one SMA element coupled between the base and the rotatable parts. A plurality of blades is connected to the base and the rotatable part. Rotation of the rotatable part drives rotation of each blade of the plurality of blades to change the size of the variable aperture.

The blades desirably move a relatively large distance on actuation of the SMA element so as to provide a relatively large range of variable aperture sizes. Such relatively large movement of the blades may be achieved by relatively great rotation of the rotatable part, which however may be difficult to achieve using single SMA elements that are directly coupled between the base and the rotatable part.

### SUMMARY

According to an aspect of the present invention, there is provided an actuator assembly comprising: a base; a rotatable part that is rotatable relative to the base about a primary axis; and one or more actuating units each configured to apply an actuating force capable of rotating the rotatable part relative to the base about the primary axis, each actuating unit comprising: a body portion; a shape memory alloy, SMA, element connected between the body portion and one of the base and the rotatable part and configured, on actuation of the actuating unit, to apply an input force to the body portion; a force-modifying element coupling the body portion and the one of the base and the rotatable part and configured such that the input force is modified to give rise to the actuating force; and a coupling element coupling the body portion to the other of the base and the rotatable part and capable of transmitting the actuating force to the other of the base and the rotatable part.

In some embodiments, the actuating unit is configured to amplify a change in actuation amount of the SMA element to a relatively greater amount of movement of a portion of the coupling element coupled to the other of the base and the rotatable part. In alternative embodiments, the actuating unit is configured to amplify the magnitude of the input force to a relatively greater magnitude of the actuation force.

The change on actuation amount of the SMA element may also be referred to as the stroke of the SMA element. Provision of the actuating unit for amplifying the stroke of the SMA element may result in an increase in the rotation of the rotatable part relative to the base compared to an actuator assembly in which the SMA element is directly connected between the rotatable part and the base. Such an increased rotation may be desirable in a variety of actuator assemblies. When used as part of a variable aperture assembly, for example, the increased rotation may extend the range of motion of blades of the variable aperture assembly, thereby increasing the range of size of variable aperture achievable by the variable aperture assembly. Alternatively, provision of the actuating unit for amplifying input force may allow heavier rotatable parts to be rotated more reliably or allow more accurate positioning of the rotatable part relative to the base.

The input force is the force provided by the SMA element, for example tension in the SMA element. The SMA element may be elongate. The SMA element may be an SMA wire. The actuation amount of the SMA element may be the change in length of the SMA element on actuation of the SMA element. Actuation of the SMA element may be contraction of the SMA element. The portion of the coupling element coupled to the other of the base and the rotatable part may be equivalent to the portion of the other of the base and the rotatable part coupled to the coupling element and correspond to the position at which a force is applied to the other of the base and the rotatable part via the coupling element.

In its most general sense, the present invention relates to actuator assemblies providing for relative rotational motion between two parts (a rotary actuator assembly). A variable aperture assembly is a particular example of such a rotary actuator assembly, and much of the following description relates specifically to a variable aperture assembly. However, unless the context requires otherwise, features described in connection with embodiments of a variable aperture assembly should be considered to apply more generally to a rotary actuator assembly.

In some embodiments, the angular extent, when viewed along the primary axis, of the body portion around the primary axis is at least 60° or at least 90°. The angular extent of the body portion may alternatively be at least 45°, at least 80° or at least 135°. The body portion may thus be relatively large, allowing the space around the actuator assembly to be used effectively to improve stroke amplification of the actuating unit.

In some embodiments, when viewed along the primary axis, the SMA element, the body portion and the coupling element extend in a loop around the primary axis. The SMA element, the body portion and the coupling element may be arranged in series to wrap around the primary axis. A majority (that is at least 50%, optionally at least 75% or at least 90%) of the SMA element, the body portion and the coupling element may not overlap when viewed radially outwards from the primary axis. The combined angular extent around the primary axis of the combination of the SMA element, the body portion and the coupling element may be at least 90°, preferably at least 150°, at least 180° or at least 300°. The space around the variable aperture assembly may thus be effectively used and the dimensions of the actuating unit in directions radially away from the primary axis may be reduced.

Some embodiments comprise two actuating units configured, on actuation, to rotate the rotatable part relative to the base in opposite senses about the primary axis. A first actuating unit of the two actuating units may be configured, on actuation, to rotate the rotatable part relative to the base in a first sense about the primary axis and a second actuating unit of the two actuating units may be configured, on actuation, to rotate the rotatable part relative to the base in a second sense about the primary axis, wherein the second sense is opposite to the first sense. The response time and accuracy of rotational positioning may thus be improved. The two actuating units, in particular the body portion and optionally the SMA element, force-modifying element and/or coupling element, may be geometrically congruent. The two actuating units may be arranged with mirror symmetry about an axis orthogonal to the primary axis or with two-fold rotational symmetry about the primary axis. Alternatively, a single actuating unit may be provided that is opposed by a biasing force, for example due to a spring or other resilient element.

In some embodiments, the SMA elements of the two actuating units are substantially parallel to each other and arranged on opposite sides of the primary axis. The SMA elements of the two actuating units may be substantially equidistant from the primary axis. A space around the primary axis may thus be heated in a balanced manner when the SMA elements are actuated, which actuation typically is due to heating of the SMA elements. Such balanced heating may be useful for a variety of applications, for example to avoid asymmetric effects on optical elements that may be provided adjacent to the space around the primary axis. The SMA elements may be substantially parallel in that an angle between nominal lines along the length of the SMA elements may be less than 10°, for example less than 5°.

In some embodiments, a first of the two actuating units is configured such that the respective SMA element is connected between the body portion and the base, the respective force-modifying element couples the body portion and the base and the respective coupling element couples the body portion and the rotatable part; and a second of the two actuating units is configured such that the respective SMA element is connected between the body portion and the rotatable part, the respective force-modifying element couples the body portion and the rotatable part and the respective coupling element couples the body portion and the base. Such alternative mounting of actuating units may allow the arrangement of the actuating units to be tailored more variably to desired layouts.

In some embodiments, the two actuating units are configured not to overlap when viewed along the primary axis. The two actuating units may overlap when viewed perpendicularly to the primary axis. The avoidance of overlap when viewed along the primary axis may be enabled by alternative mounting of actuating units, especially when relatively large body portions or actuating units that wrap around the primary axis are provided.

In some embodiments, the body portions of the two actuating units are directly coupled to each other or are integrally formed. Actuation of the SMA element of one actuating unit may thus effect movement of the body portions of the two actuating units, thereby applying the actuating force to the other of the base and the rotatable part via the coupling elements of the two actuating units. The risk of inadvertent deformation of one of the coupling elements that does not result in rotation of the rotatable part may thus be reduced. The two coupling elements may be configured such that one coupling element is placed in tension (thereby pulling on the rotatable part) and another coupling element is placed in compression (thereby pushing on the rotatable part) on actuation of one of the SMA elements.

In some embodiments, the one or more actuating units are configured to entirely overlap with the smallest square and/or the smallest circle around the base and around the rotatable part when viewed along the primary axis. The provision of the actuating units may thus not contribute to the footprint of the actuator assembly when viewed along the primary axis, such that a compact actuator assembly may be provided.

In some embodiments, i) a nominal line along a force exerted by the SMA element on the body portion, ii) a nominal line along a force exerted by the coupling element on the body portion and iii) a nominal line along a force exerted by the force-modifying element on the body portion, are concurrent lines. The nominal lines may be concurrent in particular when the body portion is at a particular position of the body portion relative to the base and/or relative to the rotatable part. The particular position may be a starting position of the body portion, for example when the rotatable part is at a central position within a range of rotational positions relative to the base. The particular position may be a position when SMA elements of two actuating units are equally actuated and/or when any flexures do not flex and so are not deformed. Providing the forces on concurrent lines may ensure that the body portion is at equilibrium so as to reduce the risk of rotation of the body portion about the force-modifying element and/or coupling element when such rotation is not desired.

In some embodiments, the force-modifying element is configured, on actuation of the SMA element, to guide rotation of the body portion relative to the one of the base and rotatable part. The force-modifying element may define a pivot axis about which the body portion may rotate. The pivot axis may be an effective pivot axis that may change in position in dependence on the load on and position of the body portion or may be a real pivot axis that is fixedly positioned relative to the body portion and the one of the body portion and rotatable part.

In some embodiments, the force-modifying element comprises a force-modifying flexure configured to flex on actuation of the SMA element so as to guide rotation about an effective pivot axis of the body portion relative to the one of the base and rotatable part. The force-modifying flexure may be elongate. The force-modifying flexure may be stiff along its length and compliant in directions orthogonal to its length. The force-modifying flexure be configured to be placed in tension on actuation of the SMA element.

In some embodiments, the force-modifying element comprises a rotation bearing configured to guide rotation of the body portion relative to the one of the base and rotatable part about a pivot axis. The rotation bearing may be a pin joint, for example, comprising a pin on one of the body portion and the one of the base and rotatable part that engages a bearing surface, such as the inner surface of a hole, on the other of the body portion and the one of the base and rotatable part. The rotation bearing may provide a pivot axis that has a fixed position relative to the body portion and the one of the base and rotatable part.

In some embodiments, the force-modifying element comprises a bearing arrangement configured to guide translational movement of the body portion relative to the one of the base and rotatable part along a movement axis, wherein the movement axis is at an angle to the direction of the input force. The angle between the movement axis and the input force may be in the range between 45° and 90°, preferably in the range from 60° to 85°. The bearing arrangement may comprise a first bearing surface on the body portion and a second bearing surface on the one of the base and rotatable part. The first and second bearing surfaces may be translatable relative to each other, either by directly sliding on each other or due to provision of a rolling bearing element arranged between the first and second bearing surfaces and rolling along the first and second bearing surfaces on relative movement of the first and second bearing surfaces. The SMA element may be configured, on actuation, to load the bearing arrangement. So, the SMA element may urge the first and second bearing surfaces together.

In some embodiments, the coupling element allows relative movement between the body portion and the other of the base and the rotatable part in a direction orthogonal to the actuating force. The coupling element may generally also be referred to as a coupling link. The coupling element may allow rotation of the body portion relative to the other of the base and the rotating part.

In some embodiments, the coupling element comprises a coupling flexure connected between the body portion to the other of the base and the rotatable part. The coupling flexure may be elongate. The coupling flexure may be stiff along its length and compliant in a direction orthogonal to its length.

In some embodiments, the body portion, the coupling element and/or the force-modifying element are integrally formed. The relative positioning of these components may thus be reliably predetermined and be independent from any assembly of such components.

In some embodiments, the coupling element comprises a coupling bearing comprising a first bearing surface on the body portion, a second bearing surface on the other of the body and the rotatable part and a bearing element between the first and second bearing surfaces. Alternatively, the first and second bearing surface may slidingly engage with each other so that a bearing element is omitted. The first and second bearing surfaces may transmit the actuating force to the other of the base and the rotating part.

In some embodiments, each actuating unit is configured such that the respective coupling element is arranged closer to the primary axis than the respective SMA element. The SMA element may thus be positioned away from the primary axis, thereby reducing heating of a space around the primary axis due to actuation of the SMA elements. The risk of SMA elements inadvertently entering the space around the primary axis when in an unpowered or slack state, which may be undesirable, is also reduced.

In some embodiments, the actuator assembly further comprises a pair of friction surfaces that are biased against each other by a biasing force, thereby generating a static frictional force between the pair of friction surfaces for maintaining the position of the rotatable part relative to the base when the at least one actuating unit is not actuating.

In embodiment of a variable aperture assembly comprises one or more pairs of friction surfaces, each pair of friction surfaces comprising a first friction surface and a second friction surface that are biased against each other by a normal force, thereby generating static frictional forces between first and second friction surfaces for maintaining the position of the blades when the actuator is not actuating.

The static frictional forces are for maintaining the orientation of the rotational part and optionally the position of the blades, and so are deliberately chosen to be large enough to allow maintenance of the position. Unlike in conventional actuator assemblies, any frictional forces are thus not minimized. The static frictional forces may be for maintaining position while acceleration of the actuator assembly is below a hold threshold. The hold threshold may be greater than the gravitational acceleration of Earth, so greater than g (9.81 m/s2), preferably greater than 2 g or greater than 5 g, or greater than 10 g.

In some embodiments, the at least one actuating unit is arranged such that the biasing force between the pair of friction surfaces is reduced on actuation of the actuating unit, thereby reducing the static frictional force between the pair of friction surfaces. The normal force between at least one pair of friction surfaces may be reduced on actuation of the actuating unit, thereby reducing the static frictional force between the pair of friction surfaces. Such a reduction in frictional force may ensure that the actuating unit can reliably rotate a rotatable part or move the blades and set the size of the variable aperture. The static frictional force between the friction surfaces can be set higher compared to a case in which the static frictional force remains constant.

In some embodiments, the at least one actuating unit is arranged such that at least one pair of friction surfaces disengages on actuation of the at least one actuating unit. The frictional force between the friction surfaces may thus be reduced to zero, minimizing resistance to movement on actuation of the at least one actuating unit.

In some embodiments, the normal force biasing at least one pair of friction surfaces acts in a direction perpendicular to the primary axis. The normal force may extend transverse to the primary axis. The friction surfaces may be generally parallel to the primary axis.

Some embodiments comprise one or more biasing arrangements arranged to bias the pairs of friction surfaces with the biasing (normal) force, thereby giving rise to the frictional force. The at least one biasing arrangement may comprise a resilient element, such as a spring (coil spring, flexure, leaf spring) or elastic element (rubber band, etc). The at least one biasing arrangement may comprise a magnetic element. For example, the biasing arrangement may comprise a magnet on one component of the variable aperture assembly (such as the base or the rotatable part) and a magnet or ferromagnetic material on another component of the variable aperture assembly.

Some embodiments comprise a bearing arrangement that guides the rotation of the rotatable part relative to the base about the primary axis. The bearing arrangement may comprise a plain or sliding bearing, a rolling bearing or a flexure bearing, for example. The at least one actuating unit may be configured to drive rotation of the rotatable part relative to the base about the primary axis to any rotational position within a range of movement.

In some embodiments, the base is provided within a hole that extends through the rotatable part along the primary axis and/or the rotatable part is provided within a hole that extends through the base along the primary axis. The base and the rotatable part may be concentric rings. The rotatable part may be an inner ring and the base may be an outer ring.

According to another aspect of the present invention, there is provided a variable aperture assembly comprising the actuator assembly and a plurality of blades configured such that rotation of the rotatable part relative to the base effects movement of the blades, thereby changing the size of the variable aperture.

In some embodiments, each of the plurality of blades is coupled between the base and the rotatable part. Each blade is connected to the base via a first set of complementary coupling features and each blade is connected to the rotatable part via a second set of complementary coupling features.

According to another aspect of the present invention, there is provided a camera comprising the variable aperture assembly, a lens assembly, and an image capture device, wherein the optical axis of the lens assembly coincides with the primary axis, such that light passing through the variable aperture assembly passes is focused by the lens and is received by the image capture device. The camera may be a miniature camera for incorporation in a portable or wearable electronic device, for example.

In some embodiments, the variable aperture assembly is mounted on the lens assembly such that the lens assembly is received within a hole in the base or the rotatable part aligned with the primary axis. A portion, such as more than 50%, 60%, 70%, 80%, or 90%, of the variable aperture assembly may overlap with the lens assembly along the primary axis.

According to another aspect of the present invention, there is provide an electronic device incorporating the camera. The electronic device may be a portable or wearable electronic device, such as a smartphone, for example.

### BRIEF DESCRIPTION OF THE DRAWINGS

Certain embodiments of the present invention will now be described, by way of example only, with reference to the accompanying drawings in which:

FIG. 1 is a schematic plan view of a variable aperture assembly with a relatively closed variable aperture;

FIG. 2 is a schematic plan view of the variable aperture assembly of FIG. 1 with a relatively open variable aperture;

FIG. 3 is a schematic side view of a variable aperture assembly assembled on a lens assembly;

FIG. 4 is a schematic plan view of an arrangement of SMA elements for adjusting the variable aperture;

FIGS. 5A and 5B are perspective and plan views of an actuating unit forming part of the actuator assembly, and FIG. 5C is a plan view of another such actuating unit;

FIG. 6 is a schematic plan view of a variable aperture assembly with actuating units for stroke amplification;

FIG. 7 is a schematic plan view of another variable aperture assembly with actuating units for stroke amplification, with an alternative arrangement of SMA elements and coupling elements;

FIGS. 8A and 8B are schematic plan views of variable aperture assemblies with actuating units with relatively large body portions;

FIG. 9A is a schematic plan view of a variable aperture assemblies with actuating units that are alternately mounted, and FIGS. 9B and 9C show alternative arrangements of actuating units that are alternately mounted;

FIGS. 10A and 10B are schematic plan views of variable aperture assemblies with actuating units having a force-modifying element in the form of a translation bearing;

FIGS. 11A and 11B are schematic plan views of variable aperture assemblies with actuating units having connected body portions;

FIG. 12 is a schematic plan view of a variable aperture assemblies with actuating units having a coupling element in the form of a coupling bearing;

FIG. 13 is a schematic plan view of a variable aperture assembly with another type of actuating unit; and

FIG. 14A is a schematic plan view of a variable aperture assembly of the type of FIG. 10A but having a different coupling element, and FIG. 14B is a detailed view of the coupling element of FIG. 14A.

### DETAILED DESCRIPTION

Certain example devices will now be described. Where similar or identical components are used in the different examples, they will be given the same reference numerals. For efficiency, description of similar or identical elements may not be repeated between the examples and characteristics and features of elements are to be understood as applying to those elements in all examples unless the description indicates otherwise.

The following description, and the accompanying drawings, present different embodiments of a variable aperture assembly or portions of a variable aperture assembly. As previously noted, unless the context requires otherwise, these should be considered to be examples of an actuator assembly providing for relative rotational movement between a base and a rotatable part (a rotary actuator assembly). Features presented in connection with a variable aperture assembly should be considered to be more generally applicable to any rotational actuator assembly.

Furthermore, in the following description, the terms “actuator” and “actuating unit” are used broadly synonymously to refer to a part of the actuator assembly that provides a driving force to effect relative rotational movement. The embodiments presented particularly concern actuating units including one or more Shape Memory Alloy (SMA) element. This may be an SMA wire, and where the term SMA wire is used this should be considered to include other suitable forms of SMA elements. Actuation of the actuating unit is achieved by heating the SMA element (for instance, by passing an electrical current) causing it to contract.

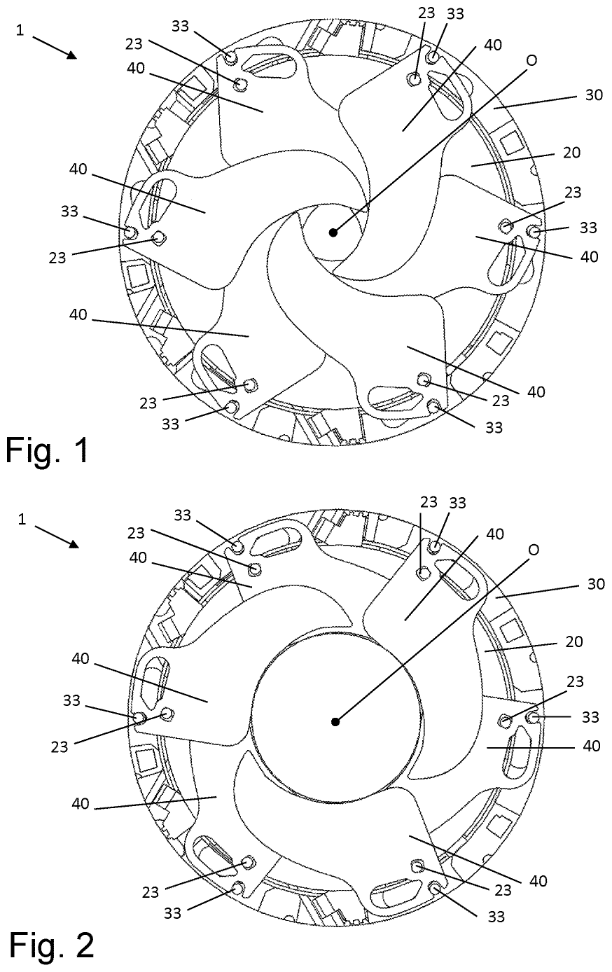

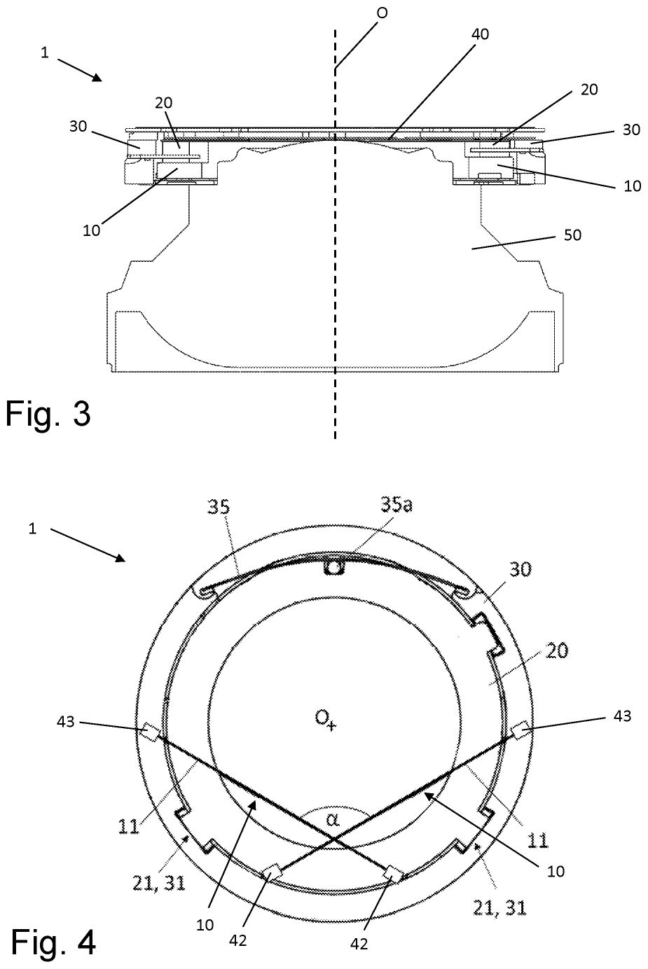

FIGS. 1 to 3 schematically depict a variable aperture assembly 1. FIG. 1 shows a plan view of the variable aperture assembly 1 with a relatively small variable aperture, and FIG. 2 shows a plan view of the variable aperture assembly 1 with a relatively large variable aperture. FIG. 3 shows a side view of the variable aperture assembly 1 in combination with a lens assembly 50.

The variable aperture assembly comprises a base 30 and a rotatable part 20. The rotatable part 20 is rotatable relative to the base 30, in particular about a primary axis O. The base 30 is shown generally disposed around the rotatable part 20 (though they may partially overlap along a radial direction perpendicular to the primary axis). Alternatively, the rotatable part 20 may surround the base 30. At least one of the base 30 and rotatable part 20 defines an aperture that allows light or fluid (for instance, gas or liquid) to pass. The aperture surrounds the primary axis O. The aperture may have rotational symmetry about the primary axis O. The base 30 and rotatable part 20 are formed generally as rings surrounding the primary axis O that light can pass through, in particular to a lens assembly 50 as shown in FIG. 3.

The base 30 may be fixed within a larger device (such as a smartphone or other portable electronic device) within which the variable aperture assembly 1 is incorporated. The base 30 may, for example, be fixed relative to a lens element of a lens assembly 50 that is provided in combination with the variable aperture assembly 1. However, in general, the base 30 may also be movable within such a larger device. The base 30 is herein used as a reference structure relative to which movement of other components is described, unless explicitly stated otherwise. The base 30 may comprise multiple parts that are fixed relative to each other to form the base 30.

The variable aperture assembly 1 may comprise a bearing arrangement (not shown in FIGS. 1 to 3) between the rotatable part 20 and the base 30. The bearing arrangement may guide rotation of the rotatable part 20 relative to the base 30. The bearing arrangement may constrain one or more degrees of freedom of movement other than the rotation. For example, the bearing arrangement may constrain movement of the rotatable part 20 relative to the base 30 along the primary axis O. The bearing arrangement may comprise rolling bearings (such as rollers or ball bearings), plain bearings (for instance, sliding bearings) or flexure bearings (for instance, arrangements of flexures constraining degrees of freedom of movement). The variable aperture assembly 1 may also comprise a biasing arrangement (not shown), for instance, an arrangement of flexures or other types of spring, for loading the bearing arrangement.

The variable aperture assembly 1 further comprises a plurality of blades 40. The blades 40 may also be referred to as leaves 40. The plurality of blades 40 defines a variable aperture. The variable aperture is preferably substantially circular, but in general may have other shapes, depending on the desired application of the variable aperture assembly 1. Each blade 40 is coupled between the base 30 and the rotatable part 20 in a manner such that rotation of the rotatable part 20 relative to the base 30 changes the size of the variable aperture.

In the embodiment of FIGS. 1 and 2, each blade 40 is coupled to the base 30 via a respective pin 33 and to the rotatable part 20 via a respective pin 23. Rotation of the rotatable part 20 relative to the base 30 causes relative movement of the pins 23, 33, thereby allowing the blades 40 to effectively pivot about the pins 23, 33 so as to change the variable aperture. The distance between the pins 23, 33 will change during rotation of the rotatable part 20 and so in the depicted embodiment each blade 40 is coupled to its respective pins 23, 33 by at least one pin being received in an elongate hole or slot formed in the blade 40 to accommodate this change. As illustrated, the pin 33 formed on the base 30 engages a slot extending to an edge of the blade 40. In an alternative embodiment, not illustrated, the pins 23, 33 are spring loaded relative to each other, by a flexure coupled to the base 30 or the rotatable part 20 (or both can be flexure coupled), allowing each pin 23 to move along a circular path around respective pin 32 on rotation of the rotatable part 20. In a further alternative, the pins may be provided upon the blades 40 and engage holes or slots formed within the base 30 and the rotatable part 20. In general, the coupling of the blades 40 to the base 30 and the rotatable part 20 may comprise any mechanism allowing movement of the blades 40 upon rotation of the rotatable part 20 so as to adjust the variable aperture.

In FIGS. 1 and 2 the variable aperture assembly 1 comprises a total of six blades 40. The blades 40 are stacked in two layers of three blades 40 on top of each other. The two layers overlap when viewed along the primary axis O. However, in general, the variable aperture assembly 1 may comprise any number of blades 40, arranged in any number of layers.

The variable aperture assembly 1 further comprises one or more actuating units 10, schematically shown in FIG. 3. Each actuating unit 10 is configured to drive rotation of the rotatable part 20 relative to the base 30 about the primary axis O. The one or more actuating units 10 may rotate the rotatable part 20 relative to the base 30 to any rotational position within a range of movement. As such, the size of the variable aperture defined by the blades 40 may be adjusted to any size within a continuous range.

FIG. 3 shows the variable aperture assembly 1 in combination with a lens assembly 50. The base 30 of the variable aperture assembly 1 may be mounted on the lens assembly 50, such that the lens assembly 50 is nested or provided within a through hole or opening of the base 30 and the rotatable part 20 which extends along a primary axis O of the variable aperture assembly 1. The primary axis O may coincide with the optical axis of the lens assembly 50. The variable aperture assembly 1 may thus adjust the amount of light entering the lens assembly 50. The light enters the lens assembly 50 along an optical path 2. The optical path 2 may be shaped, between the variable aperture assembly 1 and the lens assembly 50, as a cone around the primary axis O.

### SMA Actuating Unit

FIG. 4 schematically shows a variable aperture assembly 1 having two actuating units 10. The blades 40 are not shown, but it will be apparent that they may be coupled to the base 30 and the rotatable part 20 in the same way as described above in connection with FIGS. 1 and 2. Each actuating unit 10 of the variable aperture assembly 1 shown in FIG. 4 comprises a respective SMA wire 11. Each SMA wire 11, and thereby each actuating unit 10, is configured, on actuation, to drive rotation of the rotatable part 20 relative to the base 30 about the primary axis O. In some embodiments, the SMA wires 11 drive the rotatable part 20 to any rotational position within a range of movement relative to the base. In some other embodiments, the SMA wires 11 drive the rotatable part 20 to a set of predetermined positions within a range of movement relative to the base. The size of the variable aperture is thereby adjusted.

The SMA wires 11 are connected between the base 30 and rotatable part 20 by connection elements 42, 43. The connection elements 42, 43 may be crimps, for example. The SMA wires 11 may be directly connected between the base 30 and rotatable part 20 as illustrated, such that the connection elements 42, 43 are directly connected to the base 30 and rotatable part 20. Alternatively, intermediate elements (not shown in FIG. 4) may be connected between the connection elements 42, 43 and the base 30 and/or rotatable part 20, such that the SMA wires 11 are indirectly connected between the base 30 and rotatable part 20. Such intermediate elements transfer the force in the SMA wires 11 to the rotatable part 20 so as to effect rotation of the rotatable part 20 relative to the base 30.

As shown in FIG. 4, the variable aperture assembly 1 may comprise two actuating units 10, each comprising a respective SMA wire 11. A first SMA wire 11 (for instance, the left-hand wire) forming a first actuating unit 10 is arranged, on contraction, to apply a torque to the rotatable part 20 in a first sense (for instance, clockwise). A second SMA wire 11 (for instance, the right-hand wire) forming a second actuating unit 10 is arranged, on contraction, to rotate the rotatable part 20 in a second sense (for instance, counterclockwise). The second sense is opposite to the first sense. In alternative embodiments there may be a more or fewer SMA wires 11, for instance a larger number of SMA wires 11 operating in groups operating in opposite rotational directions. Where there is only a single SMA wire 11 there may be a biasing element (not shown) providing a return force acting in an opposite rotational direction. A set of SMA wires 11 providing torque in a certain sense may be considered to be comprised by a single actuating unit 10 such that there may be considered to be two or more actuating units 10 (FIG. 4 thus showing two actuating units 10 each comprising a single SMA wire 11). The SMA wires 11 may be arranged in a loop around the primary axis O, or part way around the primary axis O.

### Zero Hold Power

In conventional variable aperture assemblies, the actuating unit is constantly powered to maintain the position of the blades and maintain the variable aperture at a desired size. The power consumption of such conventional variable aperture assemblies is thus relatively high.

According to some embodiments, including FIG. 4, the variable aperture assembly 1 is configured such that the one or more blades 40 maintain their position when the actuating unit 10 is not actuating. As such, the actuating unit 10 only needs to be powered when the size of the variable aperture is adjusted. The energy efficiency of the variable aperture assembly 1 according to embodiments of the present invention is thus improved.

The size of the variable aperture may be maintained when the actuating unit 10 is not actuating and when acceleration of the variable aperture assembly 1 is less than or equal to a hold threshold. The hold threshold is a magnitude of acceleration of the variable aperture assembly 1. When the acceleration is equal to or less than the hold threshold, hold forces (such as frictional forces) are sufficient to maintain the size of the variable aperture. When the acceleration is greater than the hold threshold, the hold forces (such as frictional forces) may be insufficient for maintaining the position of the blades 40. The hold threshold is set by the overall force resisting movement of the blades 40 when the actuating unit 10 is not actuating, and so may be determined by the coefficients of friction of friction surfaces, the area of friction surfaces and the normal force with which friction surfaces are biased against each other. The hold threshold may be at least 1 g (9.8 m/s2) or at least 2 g (19.6 m/s2), optionally at least 5 g (49.0 m/s2), optionally at least 10 g (98.1 m/s2), optionally at least 20 g (196 m/s2), and optionally at least 50 g (490 m/s2). By increasing the hold threshold, the risk of undesired movement of the blades 40 is reduced.

### Friction Surfaces for Zero Hold Power

In some embodiments, the position of the blades 40 is maintained via an overall frictional force between components of the variable aperture assembly 1. The overall frictional force may consist of frictional forces acting between any of the components of the variable aperture assembly 1. These frictional forces may differ in magnitude, direction, and whether the frictional forces are affected by actuation of the actuating units 10. For example, some of these frictional forces may remain constant on actuation of the actuating units 10 and some other of these frictional forces may be reduced or negated on actuation of the actuating units 10. All the frictional forces may contribute to the overall frictional force that resists movement of the blades 40 when the actuating units 10 are not actuating.

FIG. 4 shows an embodiment of the variable aperture assembly 1 in which the actuating units 10 are configured to enable a reduction in the frictional force. The variable aperture assembly 1 comprises a biasing arrangement 35. The biasing arrangement 35 may comprise a leaf spring as illustrated. In general, the biasing arrangement 35 may comprise any element or combination of elements capable of applying a force between two or more components of the variable aperture assembly 1. The biasing arrangement 35 may, for example, comprise a resilient or elastic element, such as a spring (for instance, coil spring, flexure, leaf spring), rubber band, or other resilient or elastic element. The biasing arrangement 35 may be a magnetic arrangement, comprising a magnet on one part and a magnet or ferromagnetic material on the other part. The biasing arrangement 35 may be arranged between two parts or be incorporated into one or more of the parts of the variable aperture assembly 1.

The biasing arrangement 35 urges the rotatable part 20 in a first direction (downward in FIG. 4), thereby urging friction surfaces 21, 31 (provided respectively on the rotatable part 20 and the base 30) against each other. Two pairs of friction surfaces 21, 31 are illustrated, each pair of friction surfaces comprising a first friction surface 31 and a second friction surface 21 that engage one another.

The actuating units 10, in the depicted embodiment of FIG. 4 formed by the SMA wires 11, may be used to move the blades 40 to any position within the range of movement. Upon energising (that is, when drive signals are applied to the SMA wires 11 by the control circuit), the SMA wires 11 contract and apply an actuating force for moving the blades 40. The actuating force is sufficient to overcome the frictional forces at the friction surfaces 31, 32 (in some embodiments after reduction or elimination of the frictional forces due to SMA wire contraction), to drive movement of the blades. Upon ceasing power supply to the SMA wires 11, and so when stopping contraction of the SMA wires 11, the zero-hold components (for instance, the blades) remain at their position within the range of movement due to the frictional forces between the first and second friction surfaces 31, 21. In this state, the blades 40 are retained in position with zero power consumption by the variable aperture assembly 1, so the variable aperture assembly 1 may be referred to as a zero hold power actuator assembly.

The biasing arrangement 35 of FIG. 4 also comprises a coupling element 35a arranged between the biasing element and the rotatable part 20. The coupling element 35a is a ball bearing. The coupling element 35a allows the rotatable part 20 to move relative to the biasing element. The biasing arrangement 35 applies the biasing force throughout a range of movement of the rotatable part 20 relative to the base 30.

In the variable aperture assembly 1 of FIG. 4, the SMA wires 11 are angled relative to one another at an angle α and relative to the biasing force applied by the biasing arrangement 35 at an angle α/2. As such, a relatively smaller proportion of the stress in the SMA wires 11 is used to reduce the force applied by the biasing arrangement 35 (and so to reduce the frictional force between the first and second friction surfaces 31, 21) and a relatively greater proportion of the stress of the SMA wires 11 is capable of effecting rotation of the rotatable part 20. Equal actuation of the SMA wires 11 reduces the frictional force without rotating the rotatable part 20. Unequal actuation of the SMA wires 11 rotates the rotatable part 20. The angle α (and so the angle α/2) may be selected in dependence on the magnitude of the biasing force applied by the biasing arrangement, the coefficient of friction and area of the friction surfaces 21, 31, and the actuation force applied on actuation of the SMA wires 11.

In FIG. 4, the SMA wires 11 cross over when viewed along the primary axis O. The SMA wires 11 are thus longer compared to a situation in which the SMA wires 11 are not allowed to cross over. The SMA wires 11 are allowed to cross over because the depicted angle α is relatively large. For smaller angles α, the SMA wires 11 may not need to cross over while maintaining the same length of SMA wire 11.

The first and second friction surfaces 21, 31 may engage each other throughout the range of movement. So, in normal use (that is, under actuation of the actuator 10 for moving the rotatable part 20), at least some of the first and second friction surfaces 21, 31 may remain in engagement with one another (even if the actuation of the SMA wires 11 reduces the frictional force). Alternatively, the first and second friction surfaces 21, 31 may disengage on actuation of the actuator 10 (if the actuation force provided by the SMA wires 11 exceeds the biasing force provided by the biasing arrangement).

### Actuating Units for Stroke Amplification

As explained in relation to FIGS. 1 and 2, relative movement of the pins 23, 33 effects movement of the blades 40 so as to adjust the size of the variable aperture. The blades 40 desirably move a relatively large distance on actuation of the actuating units 10 so as to provide a relatively large range of variable aperture sizes. Providing actuating units 10 consisting of single SMA wires 11, such as those of FIG. 4, may however lead to a limited achievable amount of rotation of the rotatable part 20 due to limitations on the stroke achievable by the SMA wires 11. Such stroke limitations may, to some degree, be offset by arranging the pins 23, 33 closer together, thereby amplifying a given amount of rotation of the rotatable part 20 to a greater amount of movement of the blades 40. However, the proximity of the pins 23, 33 may be limited by manufacturing considerations and tolerances, as well as increasing frictional forces between the pins 23, 33 and blades 40 as the pins 23, 33 are arranged closer together. More generally, regardless of the mechanism for coupling the blades 40 to the base 30 and rotatable part 20, there may be limitations on the achievable amount of blade movement (for instance, blade rotation) for a given amount of relative movement between the base 30 and the rotatable part 20. Furthermore, high gearing in the mechanism for converting relative movement between the base 30 and the rotatable part 20 into blade movement can result in undesirable backlash in the blade drive mechanism.

It is thus desirable to amplify the stroke of the SMA wires 11 to a relatively greater amount of rotation of the rotatable part 20. In general, this could be achieved by angling the SMA wires 11 relative to the tangent about a circle around the primary axis O (such as is shown in FIG. 4). Stroke amplification could be maximised by arranging the SMA wires 11 at close to 90 degrees relative to the tangent, for example. Such an approach may, however, risk the SMA wires 11 overlapping with the variable aperture defined by the blades 40 (for example by SMA wires 11 extending towards the primary axis), lead to an increase in the footprint of the variable aperture assembly (for example by SMA wires 11 extending away from the primary axis), and/or require large bearings opposing non-tangential forces of the SMA wires 11.

The inventors have found that provision of an intermediate part 14 as part of the actuating unit 10 to achieve stroke amplification of the SMA wires 11 to a relatively greater amount of rotation of the rotatable part 20 may allow a relatively large range of variable aperture sizes to be achieved. Such an intermediate part 14 may be configured, in combination with an SMA wire 11, so as to at least partially address the drawbacks of stroke amplification of actuating units 10 consisting of single SMA wires 11.

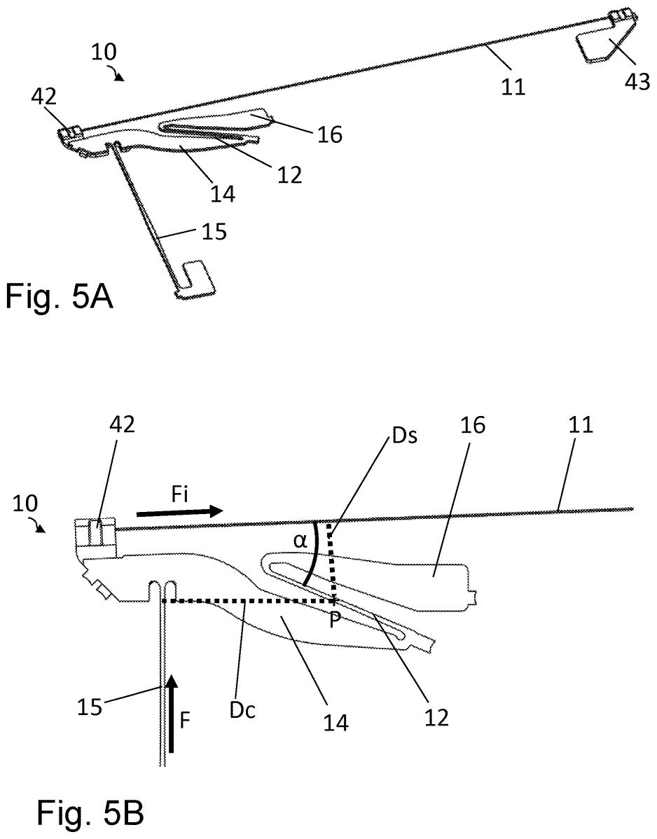

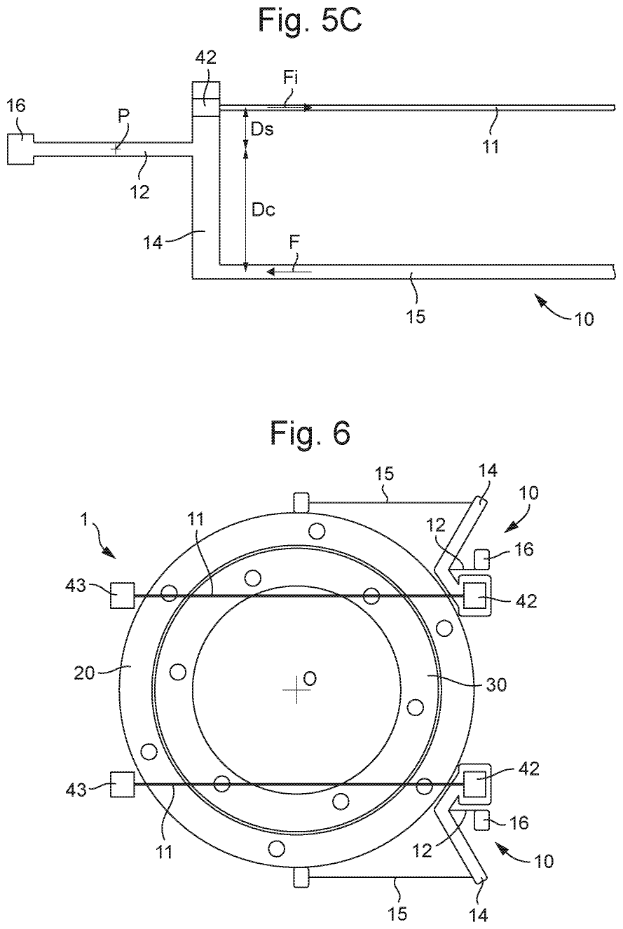

FIGS. 5A to 5C show embodiments of actuating units 10 comprising an intermediate part 14 and achieving stroke amplification of the SMA wire 11. The actuating units 10 of FIGS. 5A to 5C may be implemented in the variable aperture assembly 1 described in relation to FIGS. 1 to 4, for example. FIGS. 6 to 14 show variable aperture assemblies 1, such as those described in relation to FIGS. 1 to 4, comprising various types of actuating units 10 with intermediate parts 14 for stroke amplification.

FIG. 5A shows a perspective view of an example of the actuating unit 10. FIG. 5B shows part of the actuating unit 10 in plan view. A single actuating unit 10 is shown in FIGS. 5A and 5B, but it will be appreciated that the variable aperture assembly 1 generally has multiple actuating units 10 (typically a pair of opposing actuating units 10), each of which may include the same components described with reference to FIGS. 5A and 5B.

The actuating unit 10 includes the intermediate part 14, herein also referred to as a body portion 14, to which several other components of the actuating unit 10 are connected as described below. Typically, the body portion 14 is relatively rigid compared to the other components of the actuating unit 10 and does not deform significantly on actuation of the actuating unit 10. In some examples, the body portion 14 is not a distinct part of the actuating unit 10. For example, the body portion 14 may be defined as part of one of the other components of the actuating unit 10 or simply as a connection point between other components of the actuating unit 10.

The actuating unit 10 also includes a force-modifying element 12, here depicted as a force-modifying flexure 12. The force-modifying flexure 12 is connected between the body portion 14 and the base 30. One end of the force-modifying flexure 12 is connected to the body portion 14. The other end of the force-modifying flexure 12 is connected to the base 30, for example via a foot portion 16. The foot portion 16 is fixed relative to the base 30. The force-modifying flexure 12 allows the body portion 14 to pivot relative to the base 30 about an effective pivot axis P. Although the effective pivot axis P is shown in FIG. 5B as being positioned in the middle of force-modifying flexure 12, the effective pivot axis P may have a different position and also need not lie on the force-modifying flexure 12. Pivotal movement of the body portion 14 relative to the base 30 is initially in a direction that is substantially perpendicular to the force-modifying flexure 12.

The actuating unit 10 also includes an SMA element 11, depicted in the form of an SMA wire 11. The SMA wire 11 is connected between the body portion 14 and the base 30. One end of the SMA wire 11 is connected to the base 30, for example by a connection part 43 such as a crimp 43. The other end of the SMA wire 11 is connected to the body portion 14, for example by a connection part 42 such as a crimp 42.

The actuating unit 10 also includes a coupling element 15. In this example, the coupling element 15 is a coupling flexure 15. The coupling flexure 15 is connected between the body portion 14 and the rotatable part 20. One end of the coupling flexure 15 is connected to the body portion 14. The other end of the coupling flexure 15 is connected to the rotatable part 20. The coupling element 15 transfers or transmits an actuating force F from the body portion 14 to the rotatable part 20. The coupling element 15 may be compliant (for example deformable) in a direction (or in multiple directions) perpendicular to the actuating force F. This allows the rotatable part 20 to move in directions other than the direction of the coupling flexure 15 and actuating force F. This can be needed, for example, where different actuating units 10 cause the rotatable part 20 to move in different directions.

In this example, the body portion 14, the force-modifying flexure 12, the coupling flexure 15 and the foot portion 16 are integrally formed, for example from a single sheet of material (such as metal). In other examples, one or more of these features, if present, may be formed from different parts or materials.

The SMA wire 11 is arranged, on contraction, to apply an input force Fi on the body portion 14. The input force Fi acts parallel to the length of the SMA wire 11. The force-modifying flexure 12 and the body portion 14 are arranged to modify the input force Fi so as to give rise to the actuating force F, which is transmitted from the body portion 14 to the rotatable part 20 by the coupling flexure 15. In particular, the input force Fi deforms the force-modifying flexure 12, thereby causing the body portion 14 to pivot about the effective pivot axis P. In simple terms, the force-modifying flexure 12 and the body portion 14 act like a lever. The force-modifying flexure 12 and the body portion 14 may modify the direction and/or the magnitude of the input force Fi so as to give rise to the actuating force F.

In the example illustrated in FIGS. 5A and 5B, the coupling flexure 15 is at an angle of ^{~}90° relative to the SMA wire 11. Also, in this example, the force-modifying flexure 12 is arranged at an angle α of ^{~}30° relative to the SMA wire 11, and the force-modifying flexure 12 is placed in tension on contraction of the SMA wire 11. Hence, on contraction of the SMA wire 11 and on resulting deformation of the force-modifying flexure 12, the body portion 14 initially moves at an angle of ^{~}60° (90°−α) relative to the length of the SMA wire 11. Thus, it will be appreciated that, in this example, the force is de-amplified and the stroke is amplified, while the direction of the forces/movements is changed by an angle of ^{~}90°.

More generally, the change in direction of the force depends on the angle between the SMA wire 11 and the coupling flexure 15. Also more generally, the change in magnitude of the force is dependent on the ratio of i) the distance Ds from the effective pivot axis P to the line on which the SMA wire 11 lies and ii) the distance Dc from the effective pivot axis P to the line on which the coupling flexure 15 lies. F/Fi is proportional to Ds/Dc. If the SMA wire 11 lies on a line that is closer to the effective pivot axis P than the line on which the coupling flexure 15 lies, then the input force Fi is de-amplified. At the same time, the movement of the end of the coupling flexure 15 connected to the body portion 14 is amplified, that is increased relative to a change in length of the SMA wire 11. Alternatively, if the SMA wire 11 lies on a line that is further away from the effective pivot axis P than the line on which the coupling flexure 15 lies, then the input force Fi is amplified. At the same time, the movement of end of the coupling flexure 15 connected to the body portion 14 is de-amplified, that is decreased relative to a change in length of the SMA wire 11. The actuating unit 10 can thus be configured to amplify movement or to amplify force due to contraction of the SMA wire 11. The actuating unit 10 can also be configured to change the direction of the input force Fi. In some examples, the actuating unit 10 is configured to change the direction of the input force Fi without changing the magnitude of the force or movement.

The ratio Ds/Dc is dependent on the location of the end of the SMA wire 11 that is connected to the body portion 14, and on the location of the end of the coupling flexure 15 that is connected to the body portion 14. By way of example, the distance Dc could be increased by connecting the coupling flexure 15 further to the left of body portion 14 shown in FIG. 5B, thereby decreasing Ds/Dc and so increasing the amount of stroke amplification. The ratio Ds/Dc is also dependent on the orientation of the SMA wire 11, and on the orientation of the coupling flexure 15. Such orientations can be defined with reference to the force-modifying flexure 12 (as above) or any suitable reference line. By way of example, the distance Ds could be decreased by angling the SMA wire 11 shown in FIG. 5B so that it passes closer to the effective pivot axis P, thereby decreasing Ds/Dc and so increasing the amount of stroke amplification. In summary, the amount by which the force-modifying flexure 12 amplifies or de-amplifies the force/stroke of the SMA wire 11 may be tailored by:
adjusting the orientation of the SMA wire 11 (and thus of the input force Fi);
adjusting the location of the connection point between the SMA wire 11 and the body portion 14 (and thus the location at which the input force Fi acts on the body portion 14);
adjusting the orientation of the coupling flexure 15 (and thus of the actuating force F); and/or
adjusting the location of the connection point between the coupling flexure 15 and the body portion 14 (and thus the location from which the body portion 14 applies the actuating force F).

In some examples, at least one actuating unit 10 (preferably each actuating unit 10) is configured such that the force-modifying flexure 12 and the body portion 14 amplifies an amount of contraction of the SMA wire 11 to a relatively greater amount of rotation of the rotatable part 20 relative to the base 30. Such amplification, for example, may be by a factor greater than 1.5, preferably greater than 2, further preferably greater than 3. It is noted that the amplification factor may differ from the ratio Dc/Ds, considering that the end of the coupling flexure 15 connected to the body portion 14 may move by a different amount relative to the base than an end of the coupling flexure 15 connected to the rotatable part 20.

As described above, in the example illustrated in FIGS. 5A and 5B, the coupling flexure 15 is at an angle of about 90 degrees relative to the SMA wire 11. This allows the actuating unit 10 to fold the rotatable part 20 in a compact manner. The angle between the coupling flexure 15 and the SMA wire 11 may be in the range from 70 to 110 degrees, preferably from 80 to 100 degrees. However, in general, the angle between coupling flexure 15 and SMA wire 11 may be outside these ranges.

For instance, in the actuating unit 10 illustrated in FIG. 5C, the force-modifying flexure 12, the coupling flexure 15 and the SMA wire 11 are substantially parallel to one another. The body portion 14 acts as a first-class lever so as to effect modification of the input force Fi to give rise to the actuating force F.

In the above-described examples, the actuating unit 10 is arranged in a plane. In particular, the SMA wire 11, the coupling flexure 15 and the force-modifying flexure 12 are arranged so as to substantially extend in a common plane, at least when the variable aperture assembly 1 is in an initial configuration. This allows for a compact configuration of the actuating unit 10. The body portion 14, when embodied by a plate, may further be arranged to extend in the plane. However, in general, the components of the actuating unit 10 need not be arranged in a common plane. The SMA wire 11 and/or the coupling flexure 15 may be angled relative to the plane, for example.

In the above-described examples, the force-modifying flexure 12 is placed in tension on contraction of the SMA wire 11. This reduces the risk of buckling of the force-modifying flexure 12, reducing the risk of damage to the variable aperture assembly 1 and making the variable aperture assembly 1 more reliable. However, the force-modifying flexure 12 could instead be arranged so as to be placed under compression on contraction of the SMA wire 11. With reference to FIG. 5B, for example, the force-modifying flexure 12 could extend to the bottom-right from the connection point between the body portion 14 and the force-modifying flexure 12, and so be placed under compression on contraction of the SMA wire 11. An arrangement in which the force-modifying flexure 12 is placed under compression is disclosed in WO 2022/084699 A1, which is herein incorporated by reference.

In the above-described examples, the actuating unit 10 includes a coupling element 15 in the form of a coupling flexure 15. In general, the coupling element 15 may be embodied by components other than the coupling flexure 15, for example by a ball bearing or plain bearing configured to transmit the actuating force F to the rotatable part 20 while allowing movement of the rotatable part 20 in directions perpendicular to the actuating force F. Such alternative examples of the coupling element 15 are disclosed by the coupling link of WO 2022/084699 A1. The coupling element 15 may (or may not) be formed by an SMA wire, which may (or may not) be integral with the SMA wire 11 and may (or may not) be driven together with the SMA wire 11. In yet further alternative examples, the coupling element 15 may correspond to a simple connection of the body portion 14 to the rotatable part 20 that does not allow movement of the rotatable part 20 in directions perpendicular to the actuating force F, for example in examples in which there is no movement of the rotatable part 20 in directions perpendicular to the actuating force F.

In the above-described examples, the actuating unit 10 includes a force-modifying element 12 in the form of a force-modifying flexure 12. In general, the actuating unit 10 may include a different type of force-modifying element 12 configured to enable the above-described movement (that is rotational movement) or other movement (for example translational movement) of the body portion 14 relative to the base 30. Such a force-modifying element 12 may include, for instance, a rigid member with one end connected to the base 30 via a suitable rotation bearing or pivoting connection (for example a pin joint) and the other end connected to the body portion 14, or a plain or rolling bearing arrangement arranged to guide translational movement of the body portion 14 relative to the base 30.

In the above-described examples, the force-modifying element 12 and the SMA wire 11 connect at one end to the base 30, and the coupling element 15 connects at one end to the rotatable part 20. In general, this arrangement may also be reversed, with the force-modifying element 12 and the SMA wire 11 connecting at one end to the rotatable part 20, and the coupling element 15 connecting at one end to the base 30.

Variable Aperture Assembly with Actuating Unit for Stroke Amplification

FIGS. 6 to 14 schematically depicts plan view of various embodiments of a variable aperture assembly 1. The variable aperture assembly 1 may be generally as described in relation to FIGS. 1 to 4, except that unlike described in relation to FIG. 4, the actuating units 10 comprise components in addition to the SMA wires 11 for amplifying stroke of the SMA wires 11. The blades 40 and pins 23, 33 are not shown in the embodiments of FIGS. 6 to 14, but it will be apparent that blades 40 may be coupled to the base 30 and the rotatable part 20 in the same way as described above in connection with FIGS. 1 and 2 (or in alternative ways, which may not be based on the use of pins).

The variable aperture assemblies 1 of FIGS. 6 to 14 comprise two actuating units 10. The actuating units 10 may generally be as described in relation to FIGS. 5A to 5C, unless stated otherwise. The actuating units 10 are generally depicted more schematically in FIGS. 6 to 14 than in FIGS. 5A to 5C.

The two actuating units 10 are arranged in opposition in FIGS. 6 to 14. With particular reference to FIG. 6, for example, arranging the actuating units 10 in opposition means that a first actuating unit 10 (the top actuating unit 10 in FIG. 6) is configured, on actuation, to rotate the rotatable part 20 in a first sense (clockwise in FIG. 6) and a second actuating unit 10 (the bottom actuating unit 10 in FIG. 6) is configured, on actuation, to rotate the rotatable part 20 in a second sense (anti-clockwise in FIG. 6) that is opposite to the first sense. The two actuating units 10 may thus drive rotation of the rotatable part 20 in opposite senses, thereby improving the response time of rotation of the rotatable part and accuracy of the rotational position thereof. Alternatively, although not shown, a single actuating unit 10 may be provided that is opposed by a resilient element such as a spring.

FIG. 6 shows a variable aperture assembly 1 comprising two actuating units 10 that are of the type described generally in relation to FIG. 5C, and comprise the body portion 14, force-modifying flexure 12 and coupling flexure 15 described in relation to FIGS. 5A and 5B. The body portion 14 acts as a first-class lever so as to achieve amplification of stroke of the SMA wire 11. Each actuating unit 10 is configured so as to amplify the stroke of the SMA wire 11 (that is generally the actuation amount of an SMA element 11, which may be the change in length of the SMA wire 11) to a relatively greater amount of rotation of the rotatable part 20 (in particular the portion of the rotatable part 20 coupled to the coupling element 15, corresponding to the location at which the actuating force Facts on the rotatable part 20) relative to the base 30. In the position of the rotatable part 20 shown in FIG. 6, the stroke amplification factor may be substantially equal to Dc/Ds in equivalence to the actuating unit 10 of FIG. 5C. This is because the coupling flexure 15 is tangential to a circle around the primary axis O, and so the end of the coupling flexure 15 connected to the body portion 14 moves essentially in tandem with the end of the coupling flexure 15 connected to the rotatable part 20. In general, however, the stroke amplification factor may diverge from the ratio Dc/Ds, for example when the coupling flexure 15 (and as such the actuating force F) is at an angle to a tangent to a circle around the primary axis O.

The two actuating units 10 are arranged on opposite sides of the primary axis O. In the depicted embodiment of FIG. 6, the actuating units 10 are arranged with mirror-symmetry about an axis (the horizontal axis) that intersects and is perpendicular to the primary axis O. The actuating units 10 extend along opposite sides of the rotatable part 20 and/or base 10, such that the primary axis O is located between the actuating units 10 when viewed along the primary axis O. The actuating units 10 may thus be arranged in a compact manner around the rotatable part 20.

In the depicted embodiment, the two SMA wires 11 are parallel to each other and are arranged on opposite sides of and equidistant to the primary axis O. As such, the heat at the centre of the variable aperture due to actuation of the SMA wires 11 (which typically heat up so as to be actuated) is balanced compared to the arrangement of SMA wires 11 shown in FIG. 4. Unbalanced heating may be undesirable, for example, when the variable aperture assembly 1 is adjacent to a lens element of lens assembly 50 due to the risk of asymmetric effects on the optical properties of the lens. In general, balanced heating may be achieved when the two SMA wires 11 are substantially parallel, for example be angled by less than 10° or less than 5°. The two SMA wires 11 may be at an acute angle to each other, for example and angle of less than 45° or less than 30° or less than 20° to achieve more balanced heating compared to the arrangement of SMA wires 11 shown in FIG. 4. In general, balanced heating may be achieved when the two SMA wires 11 are substantially equidistant from the primary axis O, for example when the difference in distance between each SMA wire 11 and the primary axis O differs by less than 10%, preferably less than 5%.

In FIG. 6, the rotatable part 20 surrounds a portion of the base 30, unlike in FIGS. 1 and 2. As already explained, the base 30 may alternatively surround the rotatable part 20.

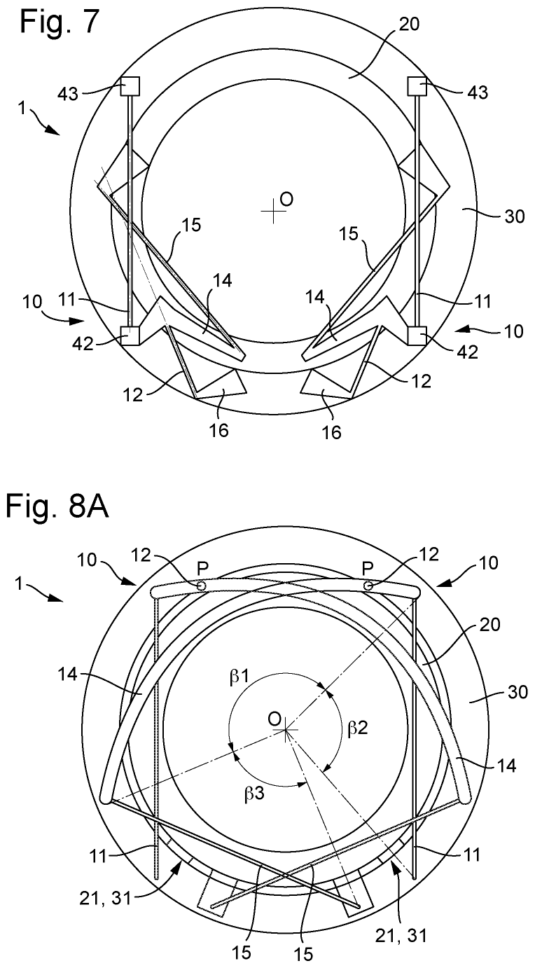

FIG. 7 depicts another embodiment of the variable aperture assembly 1. Compared to the actuating units 10 of FIG. 6, the actuating units 10 shown in FIG. 7 are arranged such that the coupling flexure 15 is generally radially inward (that is closer to the primary axis O) compared to the SMA wires 11. The connection of the coupling flexure 15 to the body portion 14 is positioned in a direction towards the primary axis O relative to the SMA wire 11. The SMA wires 11 may thus be positioned further away from the primary axis O compared to the arrangement of FIG. 6. The heat at the centre of the variable aperture due to actuation of the SMA wires 11 may thus be reduced, thereby reducing the risk of undesirably affecting any lens elements or other components arranged adjacent to the variable aperture.

A further benefit of the arrangement of FIG. 7, in which the SMA wires 11 are positioned away from the primary axis O compared to the coupling flexure 15, is that the risk of the SMA wires 11, when unpowered and slack, inadvertently passing within an optical path defined by the variable aperture is reduced. The maximum length of the SMA wire 11 and so the maximum achievable stroke of the SMA wire 11 when positioned further away from the primary axis O may however be reduced when the SMA wire 11 is constrained to fit within the footprint of the variable aperture assembly 1. The actuating unit 10 may compensate for such a reduced maximum length by achieving stroke amplification.

The coupling flexures 15 of the actuating units 10 shown in FIG. 7 are angled relative to each other and relative to the SMA wires 11, such that the actuation forces F are angled relative to each other in a manner similar to the actuating forces F applied by the SMA wires 11 described with reference to FIG. 4 (which extend substantially along the length of the SMA wires 11). Such an arrangement of actuating forces F may be particularly suitable for effective modulation of frictional forces between first and second friction surfaces in a zero-hold power actuator assembly. Although not shown specifically, the variable aperture assembly 1 of FIG. 7 may thus comprise friction surfaces 21, 31 that are biased against each other for achieving zero hold power functionality, and the actuating units 10 may be configured to reduce the frictional forces on actuation. The friction surfaces 21, 31 may, for example, be positioned at the top interface between rotatable part 20 and base 30 in FIG. 7 with a biasing force urging the rotatable part 20 upwards, noting that the coupling flexures 15 apply actuating forces F in a downward direction.

As also shown schematically in FIG. 7, the actuating unit 10 may be configured such that nominal lines along forces acting on the body portion 14 are concurrent lines. Put another way, the forces acting on the body portion 10 may intersect, in particular at a common point. With particular reference to FIG. 7, i) a nominal line along a force exerted by the SMA wire 11 on the body portion 14, ii) a nominal line along a force exerted by the coupling flexure 15 on the body portion 14 and iii) a nominal line along a force exerted by the force-modifying flexure 12 on the body portion 14, are concurrent lines. The forces exerted by the coupling flexure 15 and the force-modifying flexure 12 may be in a direction along the lengths of the flexures. Although shown specifically for FIG. 7, the actuating units 10 of any of the other embodiments may be configured in such a way, so in general i) a nominal line along a force exerted by the SMA element 11 on the body portion 14, ii) a nominal line along a force exerted by the coupling element 15 on the body portion 14 and iii) a nominal line along a force exerted by the force-modifying element 12 on the body portion 14, are concurrent lines. Such a configuration may reduce the risk of undesirable distortion of the flexure elements, for example by allowing the body portion 14 to be nominally in equilibrium when equal tension is applied to the SMA wires 11.

The three forces intersect when the body portion 14 is at a particular position of the body portion 14 relative to the base 30 and/or relative to the rotatable part 20. The particular position may be a starting position of the body portion 14, for example when the rotatable part 20 is at a central position within a range of rotational positions relative to the base 30. The particular position may be a position when the SMA wires 11 of the two actuating units 10 are equally actuated, such as shown in FIG. 7. The particular position may be a position when the coupling flexure 15 and/or the force-modifying flexure 12 are straight, that is do not flex and are not deformed, such as shown in FIG. 7.

As shown in FIG. 7, the actuating units 10 may be configured to fit within the footprint of the base 30 and rotatable part 20 when viewed along the primary axis O, thereby achieving a particularly compact form-factor of the variable aperture assembly 1. The footprint of the base 30 and rotatable part 20 in FIG. 7 may be considered to be the smallest circle that fits around the base 30 and rotatable part 20 when viewed along the primary axis O. The actuating units 10 may thus entirely overlap with this footprint. Angling of the coupling flexures 15 relative to the SMA wires 11 may facilitate the actuating units 10 overlapping with the footprint while avoiding overlap with the variable aperture defined by the blades 40 when the variable aperture is at a maximum size. The actuating units 10 may effectively bend around the primary axis O so as to overlap with the ring-shaped base 30 and/or ring-shaped rotatable part 20.

Although not shown, the actuating units 10 may alternatively be configured to fit within a square footprint. Such a square footprint may generally be available when the variable aperture assembly 1 is incorporated into a larger device, such as a smartphone camera that typically has a square footprint. The actuating units 10 may thus fit within the smallest square that fits around the base 30 and rotatable part 20 when viewed along the primary axis O. Such an arrangement of the actuating units 10 allows the space in the corners of the square to be effectively utilized, for example using an arrangement of actuating units 10 similar to that described in relation to FIG. 6, which shows the actuating units 10 in adjacent corners of a square around the variable aperture assembly 1.

Variable Aperture Assembly with Long Lever and/or Alternate Mounting of Actuating Units

The actuating units 10 of FIGS. 5 to 7 comprise body portions 14 that are relatively compact, in that the body portions 14 are schematically depicted as considerably shorter than the sides of the variable aperture assembly 1. The inventors have found that in some situations it is beneficial to make use of longer body portions 14 and make increased use of the available space around the variable aperture. Such longer body portions 14 may act as longer levers, thereby achieving a greater stroke amplification, more consistent stroke amplification factors of different actuating units 10 in view of manufacturing tolerances and/or more consistent stroke amplification over the range of actuation of the actuating unit 10, for example.

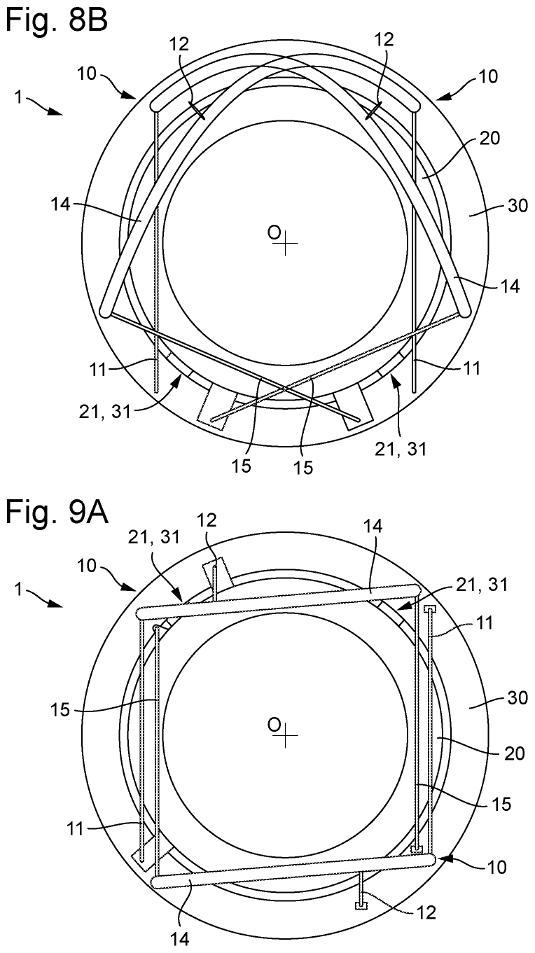

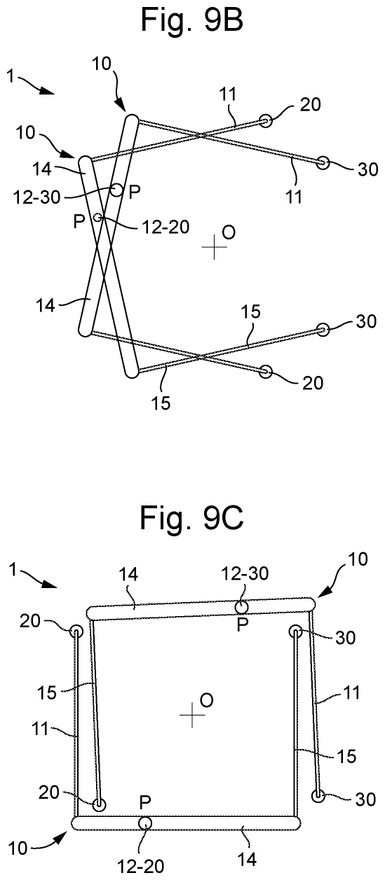

FIGS. 8 and 9 show such actuating units 10 with relatively large body portions 14. The variable aperture assembly 1 is depicted in more schematic manner in FIGS. 8 and 9 compared to other Figures and aim to illustrate the concept of long levers. Components other than the body portion 14, SMA wire 11, force-modifying element 12 and coupling element 15 (such as the connection parts 42, 43 or the foot portion 16) are omitted in some of FIGS. 8 and 9 for illustrative reasons but may nonetheless be present. FIGS. 9B and 9C do not show the base 30 and rotatable part 20, but merely the connections of the actuating units 10 thereto, although the base 30 and rotatable part 20 may nonetheless be present. It will be appreciated that the actuating units 10 and arrangements thereof shown in FIGS. 8 and 9 may be used in the variable aperture assemblies 1 described elsewhere in this application.

FIG. 8A schematically shows a variable aperture assembly 1 comprising opposing actuating units 10. Each actuating unit 10 comprises a relatively large body portion 14. In FIG. 8A, the angular extent β1 of the body portion 14 is about 160°. The angular extent β2 of the SMA wire 11 is about 90° and the angular extent β3 of the coupling flexure 15 is about 90°. The extent of each of the body portion 14, the SMA wire 11 and the coupling flexure 14 may be the distance between the ends of each of these features. The angular extents β1, β2, β3 of each of the body portion 14, the SMA wire 11 and the coupling flexure 15 may be the angular extent about the primary axis O when viewed along the primary axis O. Put another way, each of the body portion 14, the SMA wire 11 and the coupling flexure 15 extends along the majority (that is generally more than 50%, though in the depicted embodiment of FIG. 8A about 90%, 70% and 65% respectively) of the length of one of four nominal equal sides that extend in a loop around the primary axis O, such as one of four nominal equal sides of the smallest nominal square that fits around the variable aperture assembly 1.

In general, the angular extent β1 of the body portion 14 may be at least 45°, preferably at least 60°, at least 80° or at least 90°, thereby providing the body portion 14 a relatively large body portion 14. In some embodiments, such as the embodiment shown in FIG. 8A, the angular extent β1 of the body portion 14 may be at least 135°. The angular extent β2 of the SMA wire 11 may be at least 45°, preferably at least 60°, at least 80° or at least 90°. Providing a relatively long SMA wire 11, so an SMA wire 11 with relatively large angular extent, may achieve a relatively large stroke capability. The angular extent β3 of the coupling flexure 15 may be at least 45°, preferably at least 60°, at least 80° or at least 90°. Providing a relatively long coupling flexure 15, so a coupling flexure 15 with relatively large angular extent, may reduce the stiffness of the coupling flexure 15 in directions orthogonal to the actuating force F. The angular extent of the coupling element 15 in particular may be much smaller, especially in embodiments in which a coupling element 15 other than a coupling flexure 15 (such as a coupling bearing) is provided.

As shown in FIG. 8A, the body portion 14 may be curved between its ends, for example between its connection points to the SMA wire 11 and to the coupling flexure 15. The body portion 14 may curve in the same sense as a circle around the primary axis O. The body portion 14 may thus effectively bend around the primary axis O so as to align with the ring shape of the rotatable part 20 and base 30, thereby allowing the body portion 14 to made longer without extending the footprint of the variable aperture assembly 1. The body portion 14 may be curved such that a middle (for example the centre) of the body portion between its ends is closer to the primary axis O than the ends of the body portion 14.

In the embodiment of FIG. 8A, the SMA wire 11, the body portion 14 and the coupling flexure 15 wrap around the primary axis O, or in other words extend in a loop around the primary axis O. So, the SMA wire 11, the body portion 14 and the coupling flexure 15 may only minimally overlap at the ends, but the majority (that is at least 50%, optionally at least 75% or at least 90%) of the SMA wire 11, the body portion 14 and the coupling flexure 15 may not overlap when viewed radially outwards from the primary axis O. The extent of the actuating unit 10 in a direction radially outward from the primary axis O may thus be reduced. The combined angular extent β1+2+β3 of the combination of the SMA wire 11, the body portion 14 and the coupling flexure 15 is approximately equal to the sum of the angular extents of each of the SMA wire 11, the body portion 14 and the coupling flexure 15, and so about 340° in FIG. 8A. In general, the combined angular extent β1+2+β3 may be at least 90°, preferably at least 150° or at least 180°. The combined angular extent β1+2+33 may, in some embodiments (not shown) be more than 360° such that the SMA wire 11 and the coupling flexure 14 of the same actuating unit 10 cross over or overlap in angular extent when viewed along the primary axis O.

The actuating unit of FIG. 8A comprises a force-modifying element 12 schematically depicted as a rotation bearing 12, which may be embodied by a pin joint, for example, that is a pin protruding from the base 30 through a corresponding hole in the body portion 14 so as to allow the body portion 14 to rotate about a pivot axis P defined by the pin. Such a pin joint may generally also be provided by a pin protruding from the body portion 14 that engages a corresponding hole in the base 30.

FIG. 8B schematically shows another variable aperture assembly 1 comprising actuating units 10 with relatively large body portions 14. Compared to the actuating units 10 if FIG. 8A, the actuating units 10 of FIG. 8B comprise force-modifying elements 12 in the form of force-modifying flexures 12. The body portions 14 are curved in the same sense as described in relation to FIG. 8A, except that the curvature of the body portions 14 varies along the extent of the body portions 14. The body portions 14 may thereby be designed, for example, to avoid clashing with other components of the variable aperture assembly 1, for example to avoid overlap (when viewed along the primary axis) of the body portion 12 of one actuating unit 10 and the force-modifying flexure 12 of another actuating unit 10.

The actuating units 10 of FIGS. 8A and 8B overlap with each other when viewed along the primary axis O. For example, the two coupling flexures 15 overlap, the two body portions 14 overlap and the SMA wire 11 of each actuating unit 10 overlaps with the body portion 14 and coupling flexure 15 of the other actuating unit 10. Such overlap achieves a compact arrangement of the actuating units 10 within the footprint of the variable aperture assembly 1 but may add to the height of the variable aperture assembly 1 along the primary axis O and/or make assembly of the actuating units 10 in the variable aperture assembly 1 more complex.

FIG. 9A schematically shows another variable aperture assembly 1 comprising actuating units 10 with relatively large body portions 14, where the actuating units 10 are arranged not to overlap when viewed along the primary axis O. The two actuating units 10 may overlap when viewed perpendicularly to the primary axis O. Overlap of the actuating units 10 when viewed along the primary axis O is avoided by alternately mounting the actuating units 10 to the base 30 and to the rotatable part 20. In particular, the SMA wire 11 and the force-modifying flexure 12 of a first actuating unit 10 (the bottom actuating unit 10 in FIG. 9A) are connected to the base 30 and the coupling flexure 15 of the first actuating unit 10 is connected to the rotatable part 20. The SMA wire 11 and the force-modifying flexure 12 of a second actuating unit 10 (the top actuating unit 10 in FIG. 9A) are connected to the rotatable part 20 and the coupling flexure 15 of the second actuating unit 10 is connected to the base 30. The two actuating units 10 may otherwise be configured equally, that is have the same arrangement of body portion 14, SMA wire 11, force-modifying flexure 12 and coupling flexure 15. Overlap of the two actuating units 10 is thus avoided without changing the design of one of the actuating units 10. The SMA wires 11 of the two actuating units 10 are also arranged on opposite sides of the primary axis O, thereby enabling relatively balanced heating of the centre of the variable aperture on actuation of the SMA wires 11.

Each of the actuating units 10 of FIG. 9A wraps around the primary axis O, such that the SMA wire 11, the body portion 14 and the coupling flexure 15 are arranged on adjacent three sides of a nominal square around the variable aperture assembly 1. The body portions 14 of the opposing actuating units 10 are arranged on opposite sides of the primary axis O. The SMA wire 11 of the first actuating unit 10 is arranged on the same side as the coupling flexure 15 of the second actuating unit 10, and the coupling flexure 15 of the first actuating unit 10 is arranged on the same side as the SMA wire 11 of the second actuating unit 10. In the depicted embodiment, the SMA wire 11 of one actuating unit 10 is parallel to the coupling flexure 15 of another actuating unit 10, though in general the SMA wire 11 and coupling flexure 15 of different actuating units 10 could be arranged at small angles to each other while avoiding overlap.

FIGS. 9B and 9C show alternative arrangements of actuating units 10 that are alternately mounted to the base 30 and to the rotatable part 20. The base 30 and the rotatable part 20 are not depicted, but connections of the actuating unit 10 to the base 30 and to rotatable part 20 are indicated by the relevant reference numeral. The arrangement of the actuating units 10 of FIG. 9C is in essence as described in relation to FIG. 9A, although the force-modifying element 12 is schematically shown as a rotation bearing 12 instead of a force-modifying flexure 12. The arrangement of the actuating units 10 of FIG. 9B is shown to illustrate that overlap need not be avoided in arrangements with alternate mounting of the actuating units 10, for example depending on a desired footprint of the variable aperture assembly 1.

Although the concept of alternate mounting of the actuating units 10 is shown in FIGS. 9A to 9C specifically in combination with a relatively large body portion, it will be apparent that such alternate mounting may be used in combination with any of the other actuating units 10 described herein.

Actuating Unit with Translating Body Portion and/or Connected Body Portions

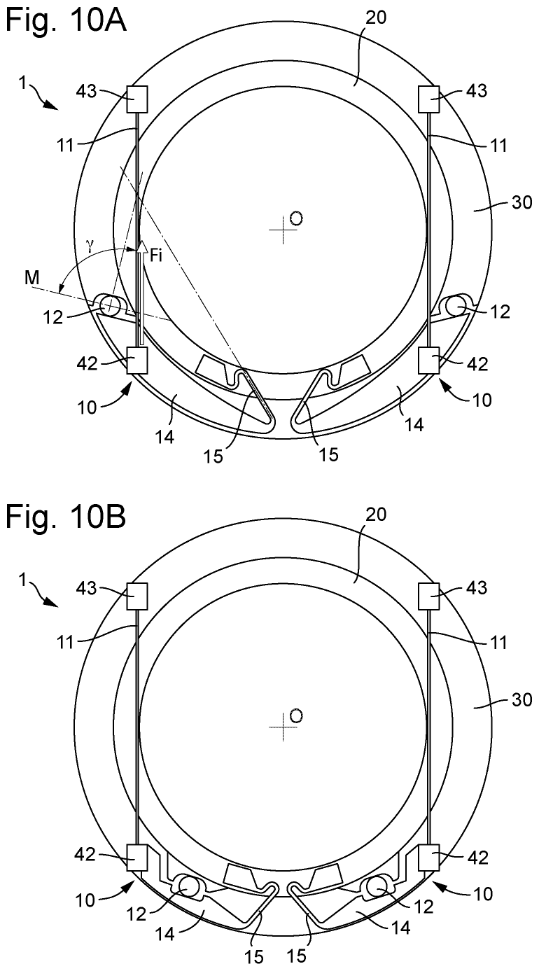

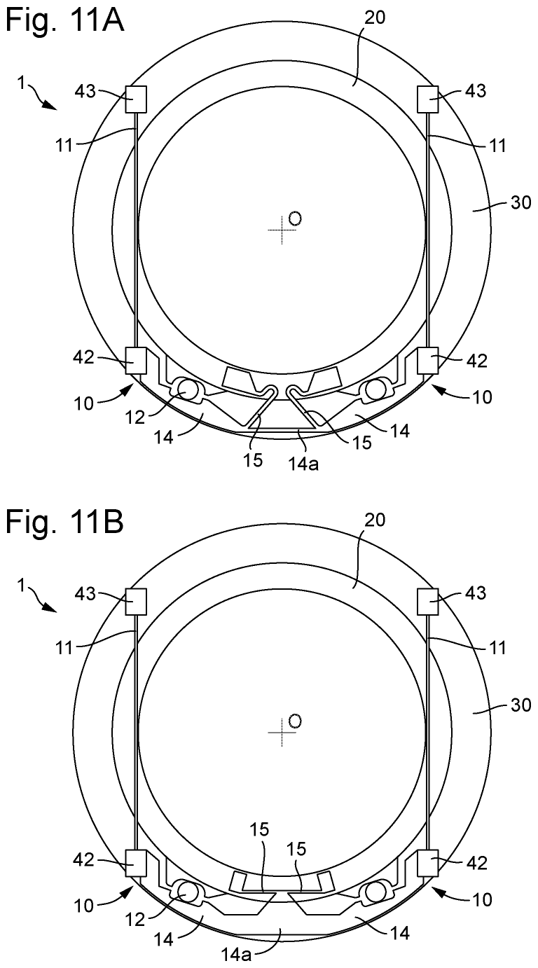

The actuating units 10 schematically shown in FIGS. 5 to 9 achieve stroke amplification by allowing rotation of the body portion 14 about a real or effective pivot axis P, thereby allowing the body portion 14 to act as a lever. FIGS. 10 and 11 schematically show variable aperture assemblies 1 of a different type of actuating unit 10, in which the body portion 14 translates at an angle to the input force Fi applied by the SMA wire 11.

With particular reference to FIG. 10A, each actuating unit 10 comprises a force-modifying element 12 in the form of a translation bearing 12. In the depicted embodiment, the translation bearing 12 couples the body portion 14 and the base 30, and so is arranged between the body portion 14 and the base 30. The translation bearing 12 is shown as a rolling bearing, comprising a rolling bearing element (such as a ball bearing or roller) between a bearing surface on the body portion 14 and a bearing surface on the base 30. In general, other types of translation bearing 12 may be used, such as a plain or sliding bearing guiding the translational movement or a flexure bearing comprising a set of two or more flexures guiding the translational movement.

The translation bearing 12 guides movement of the body portion 14 along a movement axis M that is angled relative to the input force Fi applied by the SMA wire 11. In FIG. 10A, the movement axis M defined by the left translation bearing 12 is in the top-left direction and the input force Fi acts along the SMA wire 11 in the vertical direction. The angle γ between the movement axis M and the input force Fi is about 70° in FIG. 10A. Typically, the angle γ may be in the range between 45° and 90°, for example in the range from 60° to 85°. The amount of stroke amplification increases as the angle γ approaches 90°.

On actuation of the SMA wire 11, the translation bearing 12 is loaded by urging the bearing surfaces against each other, and translational movement of the body portion 14 along the movement axis M is guided by the translation bearing 12. On translational movement of the body portion 14, the actuating force F is applied to the rotatable part 20 by the coupling flexure 15, thereby rotating the rotatable part 20 relative to the base 30. The change in length of the SMA wire 11 is amplified to a relatively greater rotation of the end of the coupling flexure 15 connected to the rotatable part 20. The amplification factor generally depends on the angle γ and the position of the end of the coupling flexure 15 connected to the rotatable part 20 relative to the primary axis O.

As also shown in FIG. 10A, the actuating unit 10 may be configured such that nominal lines along forces acting on the body portion 14 are concurrent lines. Put another way, the forces acting on the body portion 10 may intersect, in particular at a common point. With particular reference to FIG. 10A, i) a nominal line along a force exerted by the SMA wire 11 on the body portion 14, ii) a nominal line along a force exerted by the coupling flexure 15 on the body portion 14 and iii) a nominal line along a force exerted by the translation bearing on the body portion 14, are concurrent lines. The force exerted by the translation bearing 12 on the body portion 14 is perpendicular to the movement axis M. Such a configuration may reduce the risk of undesirable distortion of the flexure element and undesirable rotation about the translation bearing 12, for example by allowing the body portion 14 to be nominally in equilibrium when equal tension is applied to the SMA wires 11.

The three forces intersect when the body portion 14 is at a particular position of the body portion 14 relative to the base 30 and/or relative to the rotatable part 20. The particular position may be a starting position of the body portion 14, for example when the rotatable part 20 is at a central position within a range of rotational positions relative to the base 30. The particular position may be a position when the SMA wires 11 of the two actuating units 10 are equally actuated, such as shown in FIG. 10A. The particular position may be a position when the coupling flexure 15 is straight, that is does not flex, such as shown in FIG. 10A.

The actuating units 10 of FIG. 10A are configured such that the coupling flexure 15 and a part of the body portion 14 (in particular the part between the connection part 42 and the translation bearing 12) are placed in compression on actuation of the SMA wire 11.

FIG. 10B shows another actuating unit 10 in which the body portion 14 translates at an angle to the input force Fi applied by the SMA wire 11. The angle γ is not labelled in FIG. 10B or subsequent Figures but may be as described in relation to FIG. 10A. Compared to the actuating unit 10 of FIG. 10A, the actuating unit 10 of FIG. 10B is configured such that the components of the actuating unit 10 are placed in tension on actuation of the SMA wire 11. The risk of buckling of components of the actuating unit 10, especially of the coupling flexure 15, may thus be reduced.

The translation bearing 12 is arranged on the body portion 14 between the connection point of the SMA wire 11 to the body portion 14 and the connection point of the coupling flexure 15 to the body portion 14. The entire body portion 14 may thus be placed in tension on actuation of the SMA wire 11. The coupling flexure 15 is configured to extend away from the body portion 14 in a direction opposite to the movement of the body portion 14 on actuation of the SMA wire 11. In FIG. 10A, by contrast, the coupling flexure 15 folds back onto the body portion 14 in the direction of movement of the body portion 14 and so overlaps with the body portion 14 when viewed perpendicularly to the movement axis M.

The coupling flexures 15 of FIGS. 10A and 10B may be configured to be relatively stiff, so as to effectively convert translation of the body portion 14 into rotation of the rotatable part 20. Some compliance may be allowed by the coupling flexures 15 to allow rotation of the body portion 14 relative to the rotatable part 20.

The two opposing actuating units 10 of the variable aperture assemblies 1 of FIGS. 6 to 10 are shown as entirely separate. For example, actuation of the SMA wire 11 of one actuating unit 10 may only indirectly effect movement of the body portion 14 of the other actuating unit 10 via the coupling elements 15.

FIGS. 11A and 11B schematically show opposing actuating units 10 with coupled body portions 14. Movement of one of the body portions 14 due to actuation of the respective SMA wire 11 directly effects movement of the other body portion 14 due to a connection element 14a between the body portions 14.

With particular reference to FIG. 11A, a connection element 14a is provided between the body portions 14. The connection 14a may, as shown, be integrally formed with the body portions 14 or may fixedly connect to the body portions 14. The two body portions 14 are thus connected so as to move in tandem on actuation of one of the SMA elements 11.

The connection element 14a of FIG. 11A is a flexure that is elongate between the body portions 14. The flexure allows a force to be transmitted along the length of the flexure from one body portion 14 to another body portion 14, while allowing relative movement of the body portions 14 in a direction orthogonal to the length of the flexure. When the left SMA element 11 of FIG. 11A is actuated, for example, the left body portion 14 is urged leftward so as to apply tension in the left coupling flexure 15 for applying an actuating force to the rotatable part 20. Due to the connection part 14a, the right body portion 14 is also urged leftward so as to apply compression to the right coupling flexure 15 for applying an actuating force to the rotatable part 20. As such, the coupling flexures 15 of both actuating units 10 act on the rotatable part 20 even when only one SMA wire 11 of one of the actuating units 10 is actuated.

The connection element 14a of FIG. 11B is a relatively rigid part that fixedly connects the body portions 14, such that no relative movement of the body portions 14 is allowed. The two body portions 14 and the connection element 14a form a single larger body, and so may be referred to in combination as a common body portion. The two actuating units 10 may thus be considered to share a common body portion. The common body portion is connected to two coupling flexures 15, which may act on the rotatable part 20 on actuation of only one SMA wire 11 in the manner described with reference to FIG. 11A.

Coupling the body portions 14 together using the connection element 14a (or providing a single common body portion) may reduce the risk of undesired deformation of the coupling flexure 15 that is not converted into rotation of the rotatable part 20.

Actuating Unit with Coupling Element Formed as Bearing Arrangement

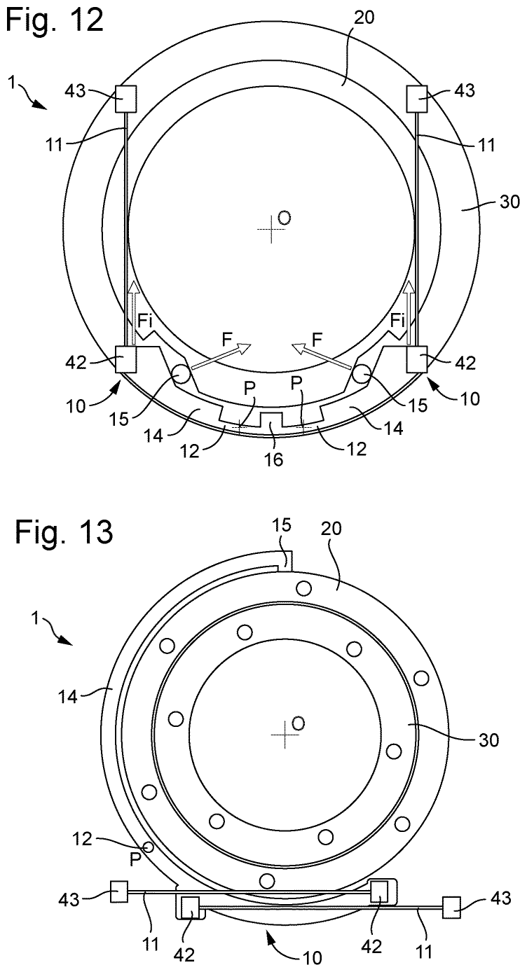

The actuating units 10 shown in FIGS. 5 to 11 comprise coupling elements 15 in the form of coupling flexures 15. Other types of coupling elements 15 may be provided instead of coupling flexures 15 in any of FIGS. 5 to 11. FIG. 12 shows an embodiment of an actuating unit 10 comprising a coupling element 15 in the form of a coupling bearing 15.

In the depicted embodiment, the coupling bearing 15 couples the body portion 14 and the rotatable part 20, and so is arranged between the body portion 14 and the rotatable part 20. The coupling bearing 15 is shown as comprising a bearing element (such as a ball bearing or roller) between a bearing surface on the body portion 14 and a bearing surface on the rotatable part 20. In general, other types of coupling bearing 15 may be used, such as a pivot bearing or any other mechanism allowing rotation of the body portion 14 relative to the rotatable part 20.

The coupling bearing 15 transfers the actuating force F to the rotatable part 20 while being compliant in directions orthogonal to the actuating force F, for example by allowing relative movement of the bearing surfaces in directions orthogonal to the actuating force F. In the depicted embodiment, the body portion 14 may rotate about effective pivot axis P provided by the force-modifying flexure 12, thereby causing rotation of the rotatable part 20 via the coupling bearing 15. With particular reference to FIG. 12, the left body portion 14 may rotate clockwise so as to achieve anticlockwise rotation of the rotatable part 20. The coupling bearing 15 allows relative rotation of the body portion 14 and the rotatable part 20.

### Alternative Actuating Units

FIG. 13 schematically depicts a variable aperture assembly comprising an actuating unit 10 of another type.

The actuating unit 10 comprises a relatively large body portion 14. The angular extent of the body portion 14 may be as described in relation to FIGS. 8 and 9, for example. In the depicted embodiment, the angular extent of the body portion 14 around the primary axis O is greater than 180°. The force-modifying element 12 is embodied by a rotation bearing, such as a pin joint, allowing rotation of the body portion 14 about pivot axis P. The body portion 14 acts as a first-class lever for achieving stroke amplification of the SMA wires 11.

The body portion 14 is effectively shared by two actuating units 10, in that two SMA wires 11 act in opposition on the body portion 14, in equivalent manner to the actuating units 10 described with reference to FIG. 11B. A first SMA wire 11 is configured to drive rotation of the body portion 14 relative to the base 30 in a first sense about the pivot axis P and a second SMA wire 11 is configured to drive rotation of the body portion 14 relative to the base 30 in a second sense, opposite to the first sense, about the pivot axis P.

The body portion 14 is coupled to the rotatable part 20 via a coupling element 15. The coupling element 15 is only shown schematically in FIG. 13 and may be configured to transfer actuating forces to the rotatable part 20 while allowing rotation of the body portion 14 relative to the rotatable part 20. The coupling element 15 may be implemented, for example, like the coupling elements 15 shown in any of FIGS. 10 to 12.

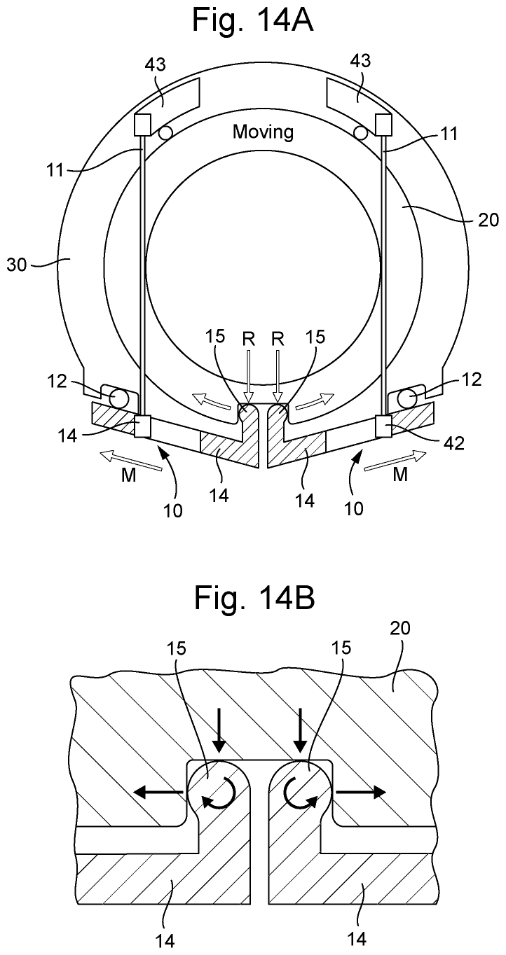

FIG. 14A schematically depicts a variable aperture assembly 1 that is of a similar type as the variable aperture assembly 1 of FIG. 10A, except for the provision of a different type of coupling element 15 for each of the actuating units 10.

FIG. 14B shows the coupling elements 15 of the variable aperture assembly 1 of FIG. 14A in detail. The coupling element 15 is a rotation bearing 15 comprising a pivot arm on the body portion 14 that engages bearing surfaces of a groove in the rotatable part 20. The pivot arm may slide relative to the bearing surfaces so as to allow rotation of the body portion 14 relative to the rotatable part 20. For example, on actuation of the left SMA wire 11 shown in FIG. 14A, the left body portion shown in FIG. 14B rotates in an anticlockwise sense thereby urging the pivot arm leftwards against the bearing surface of the rotatable part 20 so as to drive rotation of the rotatable part 20 in a clockwise sense.

The coupling element 15 of FIG. 14B may generally be used in any of the variable aperture assemblies 1 described herein, for example in place of the coupling elements 15 of FIGS. 6 to 13.

### Other Variations

It will be appreciated that there may be many other variations of the above-described examples.

Many of the actuating units 10 herein have been described as comprising a force-modifying element 12 in the form of a force-modifying flexure 12. In general, the force-modifying flexure 12 may be replaced by any element or mechanism capable of guiding rotation of the body portion 14 about a real or effective pivot axis. It will be apparent that the stroke amplification may be achieved in equivalent manner to that described by replacing the force-modifying flexure 12 with a rotation bearing, such as a revolute joint (for example a pin joint) and/or comprising a contact bearing that is capable of rolling and/or sliding relative to the bearing surface of the rotation bearing.

It is apparent from FIGS. 7, 8A/B, 10A/B and 11A and 12 that the coupling elements 15 are configured to apply actuating forces F that are angled relative to each other in a manner similar to those described in relation to FIG. 4. The variable aperture assembly 1 of any of these Figures may comprise friction surfaces (although not specifically shown in some of the Figures) so as to implement zero hold power functionality as described with reference to FIG. 4. In FIGS. 10A/B and FIG. 11A, such friction surfaces may be biased together by an upward biasing force (not shown) that is opposed and thereby may be reduced by the actuating forces having a component in the downward direction.

Similarly, the actuating units 10 of FIGS. 9A to 9C that are alternately mounted to the rotatable part 20 and the base 30 may apply forces (be it the actuating force F or the input force Fi) to the rotatable part that are generally angled relative to each other in a manner similar to those described in relation to FIG. 4, and so may implement zero hold power functionality.

The embodiments of FIGS. 6 to 14 comprise actuating units 10 configured to provide stroke amplification of the SMA element 11. As described in relation to FIG. 5B, the actuating units 10 may alternatively be configured for force amplification of the input force Fi to a relatively greater actuating force F, for example by repositioning the pivot axis P (for example by repositioning the force-modifying flexure 12 or the rotation bearing 12) such that the lever arm provided by the body portion 14 to the input force Fi is greater than the lever arm provided by the body portion 14 to the actuating force. Such force amplification may be desirable for moving particularly heavy rotatable parts 20, for example. The rotational position of the rotatable part 20 may be more accurately set by providing such force amplification (and thereby effectively stroke de-amplification).

Although the variable aperture assembly 1 has been described in the context of an optical system, for adjusting the amount of light entering a lens assembly 50, it will be appreciated that the variable aperture assembly 1 may be used in other applications. The variable aperture assembly 1 may be used to adjust passage of any material though an aperture. For example, the variable aperture assembly 1 may be used as a variable valve for adjusting the flow of a fluid (for example a liquid or a gas, such as air) though a conduit. The variable aperture assembly 1 could also be used to control the passage of particles other than photons, for example to adjust a charged particle beam, such as in an electron microscope or the like.

The provision of a rotatable part 20 that is rotatable relative to the base 30, as well as the actuating units 10 for driving such rotation, has been described in the context of a variable aperture assembly 1. It will be apparent that the actuating units 10 described herein may be used to drive rotation of a rotatable part 20 relative to a base 30 for any other purpose. The variable aperture assembly 1 described herein may thus be more generally referred to as an actuator assembly 1. The base 30 may also be referred to as a support structure 10.

One example of another type of actuator assembly 1 comprising a rotatable part 20 and the actuating units 10 is an actuator assembly 1 comprising a third part, where a helical bearing arrangement guides helical movement of the third part relative to the rotatable part and a translational bearing arrangement guides translational movement of the third part relative to the base 30. The actuating units 10 may be used to drive rotation of the rotatable part 20 relative to the base 30, which rotation is converted by the helical bearing arrangement and the translational bearing arrangement into translational movement of the third part along the primary axis O. The third part may, for example, comprise one or more lenses and can thus be used to effect auto-focus or zoom functionality in a camera apparatus.

### SMA

The above-described SMA actuator assemblies comprise at least one SMA element. Each SMA element may be divided into one or more SMA element segments. The term ‘shape memory alloy (SMA) element’ may refer to any element comprising SMA. The SMA element may be described as an SMA wire. The SMA element may have any shape that is suitable for the purposes described herein. The SMA element may be elongate and may have a round cross section or any other shape cross section. The cross section may vary along the length of the SMA element. The SMA element might have a relatively complex shape such as a helical spring. It is also possible that the length of the SMA element (however defined) may be similar to one or more of its other dimensions. The SMA element may be sheet-like, and such a sheet may be planar or non-planar. The SMA element may be pliant or, in other words, flexible. In some examples, when connected in a straight line between two components, the SMA element can apply only a tensile force which urges the two components together. In other examples, the SMA element may be bent around a component and can apply a force to the component as the SMA element tends to straighten under tension. The SMA element may be beam-like or rigid and may be able to apply different (for instance, non-tensile) forces to elements. The SMA element may or may not include material(s) and/or component(s) that are not SMA. For example, the SMA element may comprise a core of SMA and a coating of non-SMA material. Unless the context requires otherwise, the term ‘SMA element’ may refer to any configuration of SMA material acting as a single actuating element which, for example, can be individually controlled to produce a force on an element. For example, the SMA element may comprise two or more portions of SMA material that are arranged mechanically in parallel and/or in series. In some arrangements, the SMA element may be part of a larger SMA element. Such a larger SMA element might comprise two or more parts that are individually controllable, thereby forming two or more SMA elements. The SMA element may comprise an SMA wire, SMA foil, SMA film or any other configuration of SMA material. The SMA element may be manufactured using any suitable method, for example by a method involving drawing, rolling, deposition, sintering or powder fusion. The SMA element may exhibit any shape memory effect, for instance, a thermal shape memory effect or a magnetic shape memory effect, and may be controlled in any suitable way, for instance, by Joule heating, another heating technique or by applying a magnetic field.

The SMA element may typically comprise nitinol (nickel titanium), although generally other types of SMA material may be used.

### Alternative Ways of Heating SMA

The heating of the heat-activated actuator(s), such as SMA material, in order to cause the moving portion to move, could be achieved in a number of ways.

In one arrangement, the material could be heated by passing a current through it. This current might come from a local or external power supply. Alternatively, the current might be induced in the wire by inductive coupling with an external alternating field. Where there are two actuators, the two actuators might be designed so that they couple to two different frequencies of the inductive power source, thus allowing the two actuators to be heated differentially.

In another arrangement, the material could be heated by external radiation such as a visible or infra-red laser. The external radiation could be focussed so that one actuator is heated preferentially over another actuator, thus allowing differential actuation. Alternatively, or additionally, different actuators, or portions of the actuators, could be treated (for example with a surface coating) so that the different actuators heat at different rates depending on the nature (for instance, the frequency) of the incident radiation.

1. An actuator assembly comprising:
a base;
a rotatable part that is rotatable relative to the base about a primary axis; and
one or more actuating units each configured to apply an actuating force capable of rotating the rotatable part relative to the base about the primary axis, each actuating unit comprising:
a body portion;
a shape memory alloy, SMA, element connected between the body portion and one of the base and the rotatable part and configured, on actuation of the actuating unit, to apply an input force to the body portion;
a force-modifying element coupling the body portion and the one of the base and the rotatable part and configured such that the input force is modified to give rise to the actuating force; and
a coupling element coupling the body portion to the other of the base and the rotatable part and capable of transmitting the actuating force to the other of the base and the rotatable part.

2. An actuator assembly according to claim 1, wherein the actuating unit is configured to amplify a change in actuation amount of the SMA element to a relatively greater amount of movement of a portion of the coupling element coupled to the other of the base and the rotatable part.

3. An actuator assembly according to claim 1, wherein the angular extent, when viewed along the primary axis, of the body portion around the primary axis is at least 60° or at least 90°.

4. An actuator assembly according to claim 1, wherein, when viewed along the primary axis, the SMA element, the body portion and the coupling element extend in a loop around the primary axis.

5. An actuator assembly according to claim 1, comprising two actuating units configured, on actuation, to rotate the rotatable part relative to the base in opposite senses about the primary axis.

6. An actuator assembly according to claim 5, wherein the SMA elements of the two actuating units are substantially parallel to each other and arranged on opposite sides of the primary axis; wherein the SMA elements of the two actuating units are substantially equidistant from the primary axis;
wherein a first of the two actuating units is configured such that the respective SMA element is connected between the body portion and the base, the respective force-modifying element couples the body portion and the base and the respective coupling element couples the body portion and the rotatable part, and wherein a second of the two actuating units is configured such that the respective SMA element is connected between the body portion and the rotatable part, the respective force-modifying element couples the body portion and the rotatable part and the respective coupling element couples the body portion and the base;
wherein the two actuating units are configured not to overlap when viewed along the primary axis; and/or
wherein the body portions of the two actuating units are directly coupled to each other or are integrally formed.

7. An actuator assembly according to claim 1, wherein the one or more actuating units are configured to entirely overlap with a smallest square and/or a smallest circle around the base and around the rotatable part when viewed along the primary axis; or
wherein i) a nominal line along a force exerted by the SMA element on the body portion, ii) a nominal line along a force exerted by the coupling element on the body portion and iii) a nominal line along a force exerted by the force-modifying element on the body portion, are concurrent lines.

8. An actuator assembly according to claim 1, wherein the force-modifying element is configured, on actuation of the SMA element, to guide rotation of the body portion relative to the one of the base and rotatable part.

9. An actuator assembly according to claim 8, wherein the force-modifying element comprises a force-modifying flexure configured to flex on actuation of the SMA element so as to guide rotation about an effective pivot axis of the body portion relative to the one of the base and rotatable part.

10. An actuator assembly according to claim 8, wherein the force-modifying element comprises a rotation bearing configured to guide rotation of the body portion relative to the one of the base and rotatable part about a pivot axis.

11. An actuator assembly according to claim 1, wherein the force-modifying element comprises a bearing arrangement configured to guide translational movement of the body portion relative to the one of the base and rotatable part along a movement axis, wherein the movement axis is at an angle to the direction of the input force.

12. An actuator assembly according to claim 1, wherein the coupling element allows relative movement between the body portion and the other of the base and the rotatable part in a direction orthogonal to the actuating force.

13. An actuator assembly according to claim 12, wherein the coupling element comprises a coupling flexure connected between the body portion to the other of the base and the rotatable part.

14. An actuator assembly according to claim 12, wherein the coupling element comprises a coupling bearing comprising a first bearing surface on the body portion, a second bearing surface on the other of the base and the rotatable part, and a bearing element between the first and second bearing surfaces.

15. An actuator assembly according to claim 1, wherein each actuating unit is configured such that the respective coupling element is arranged closer to the primary axis than the respective SMA element.

16. An actuator assembly according to claim 1, wherein the actuator assembly further comprises a pair of friction surfaces that are biased against each other by a biasing force, thereby generating a static frictional force between the pair of friction surfaces for maintaining the position of the rotatable part relative to the base when the at least one actuating unit is not actuating.

17. An actuator assembly according to claim 16, wherein the at least one actuating unit is arranged such that the biasing force between the pair of friction surfaces is reduced on actuation of the actuating unit, thereby reducing the static frictional force between the pair of friction surfaces.

18. A variable aperture assembly comprising:
the actuator assembly of claim 1; and
a plurality of blades configured such that rotation of the rotatable part relative to the base effects movement of the blades, thereby changing the size of the variable aperture.

19. A camera comprising:
the variable aperture assembly of claim 18;
a lens assembly; and
an image capture device;
wherein the optical axis of the lens assembly coincides with the primary axis, such that light passing through the variable aperture assembly is focused by the lens and is received by the image capture device.

20. An electronic device incorporating the camera of claim 19.
